(19) United States
(12) Patent Application Publication
(10) Pub. No.: US 2024/0429635 A1
(43) Pub. Date: Dec. 26, 2024

(54) ELECTRICAL CONNECTOR AND METHOD FOR MANUFACTURING CONTACT PIN OF ELECTRICAL CONNECTOR

(71) Applicant: MITSUMI ELECTRIC CO., LTD., Tokyo (JP)

(72) Inventors: Takahiro AKAIKE, Tokyo (JP); Hiroyuki SADOHARA, Tokyo (JP); Takashi KAWASAKI, Tokyo (JP)

(21) Appl. No.: 18/745,844

(22) Filed: Jun. 17, 2024

(30) Foreign Application Priority Data
Jun. 23, 2023 (JP) 2023-103601
Jun. 23, 2023 (JP) 2023-103603

(51) Int. Cl. H01R 13/04; H01R 43/16

(52) U.S. Cl. CPC H01R 13/04; H01R 43/16

(57) ABSTRACT

An electrical connector includes a pair of contact pins. Each of the pair of contact pins is obtained by performing a pressing process with respect to a wire rod having a rectangular cross-sectional shape. The contact pin includes a body portion having a rectangular cross-sectional shape. The body portion has an outer surface and an inner surface facing each other, and a third surface and a fourth surface facing each other. The third surface and the fourth surface are perpendicular to the outer surface and the inner surface. The body portion of each of the pair of contact pins further includes a recessed portion formed on the outer surface and a pair of protruding portions respectively protruding from portions of the third surface and the fourth surface adjacent to the recessed portion toward an outer side.

### CROSS-REFERENCE TO RELATED APPLICATION

The present application claims priorities to Japanese Patent Application No. 2023-103601 filed on Jun. 23, 2023, and Japanese Patent Application No. 2023-103603 filed on Jun. 23, 2023. The contents of the above-listed applications are incorporated by reference for all purposes.

### TECHNICAL FIELD

The present disclosure generally relates to electrical connectors and methods of manufacturing a contact pin of the electrical connector, in particular to an electrical connector used for providing a coaxial connection with a coaxial cable and a method of manufacturing a contact pin of the electrical connector.

### BACKGROUND ART

In order to provide an electrical connection between an electronic device and another electronic device through a cable, there has been widely used a combination of a receptacle connector and a plug connector. Further, an amount of data transmitted from the electronic device to the other electronic device through the cable has increased as processing capacities of electronic devices have been improved in recent years. In order to transmit a large amount of data in a short time, it is necessary to transmit a high frequency signal through the cable. Thus, there are needs of improving signal transmission characteristics of the cable, particularly, signal transmission characteristics of the cable in a high frequency band. In order to address such needs, a coaxial cable having superior signal transmission characteristics in the high frequency band has been widely used. As is well known, the coaxial cable has a coaxial structure in which a core wire for transmitting a signal, an inner insulator layer covering the core wire, an outer conductor layer (a braid layer) covering the inner insulator layer and serving as a ground earth when the signal is transmitted and a shield for preventing leak of the signal to the outside and penetration of radio waves from the outside, and an outer insulator layer covering the outer conductor layer are concentrically arranged.

In order to provide a coaxial connection with the above-mentioned coaxial cable, there has been widely used an electrical connector including a contact pin to be electrically connected to the core wire of the coaxial cable and an insulating housing for covering the contact pin. For example, patent document 1 discloses a pair of contact pins 10 and a housing 11 shown in FIG. 1, which are typically used in the above-mentioned electrical connector. FIG. 2 is a planar view showing a work in process of the contact pin 10. FIG. 3 is a horizontal cross-sectional view of the contact pin 10 taken along an A-A line in FIG. 1.

As shown in FIG. 1, each of the contact pins 10 includes a body portion 101, a contact portion 102 which protrudes from one end portion of the body portion 101 toward the tip side and should contact with a corresponding contact pin of a mating contact, a terminal portion 103 extending from another end portion of the body portion 101 toward the lower side and to be connected to a corresponding terminal of a circuit board, and a plurality of cut marks 104 protruding from the body portion 101 toward the outer side. The housing 11 includes a cylindrical portion 111 for containing a portion of the body portion 101 of the contact pin 10 extending in the front-rear direction (Z direction), and a wall portion 112 extending in the front-rear direction inside the cylindrical portion 111 so as to separate the pair of contact pins 10 in the X direction. The pair of contact pins 10 are contained in the cylindrical portion 111 of the housing 11 in a state that the contact pins 10 are insulated from each other.

Next, description will be given to processes for manufacturing the contact pin 10 with reference to FIG. 2. First, a punching process is performed with respect to a single metal plate. In the punching process, a cutter is pressed against the metal plate from the +X direction to punch the metal plate into a predetermined shape. As a result, it is possible to obtain the work in process of the contact pins 10 shown in FIG. 2. In this work-in-process stage, the contact pins 10 are connected to each other by a plurality of carriers 105. The contact pins 10 are obtained by cutting portions indicated by dotted lines in FIG. 2 in this state and separating the contact pins 10 from the carriers 105. After this cutting process, portions of the carriers 105 remain on the body portion 101 as the cut marks 104.

As described above, the contact pin 10 can be obtained by performing the punching process and the cutting process with respect to the single metal plate. However, it has been known that the above-mentioned punching process causes collapses (deformations) of corner portions of a punched surface (YZ surface) of the contact pin 10. FIG. 3 shows the cross-sectional view (horizontal cross-sectional view) of the body portion 101 of the contact pin 10 taken along the A-A line shown in FIG. 1. As shown in FIG. 3, the contact pin 10 has a first surface 106 extending on the YZ plane and located on a punching start direction side (the right side in FIG. 3), a second surface 107 facing the first surface 106 and located on a punching end direction side (the left side in FIG. 3), a third surface 108 extending on the XZ plane and located on the upper side in FIG. 3, and a fourth surface 109 facing the third surface 108 and located on the lower side in FIG. 3. In FIG. 3, a length of the first surface 106 is indicated by “L1”, a length of the second surface 107 is indicated by “L2”, a length of the third surface 108 is indicated by “L3”, and a length of the fourth surface 109 is indicated by “L4”.

In order to improve signal transmission characteristics of the electrical connector in a high frequency band, it is most preferable that the length L1 of the first surface 106 and the length L2 of the second surface 107 are equal to each other (L1=L2). However, as shown in FIG. 3, when the contact pin 10 is obtained by performing the punching process with respect to the metal plate, the corner portions on a punching start direction side (the corners of the first surface 106) are collapsed. Thus, the corners are deformed into shapes as shown by the solid lines in FIG. 3 (shapes shown by the dotted lines are ideal horizontal cross-sectional shapes without the collapses of the corners caused by the punching process). As a result, the length L1 of the first surface 106 becomes much smaller than the length L2 of the second surface 107, so that a large difference occurs between the length L1 of the first surface 106 and the length L2 of the second surface 107. Further, since the corners of the first surface 106 are collapsed, the third surface 108 and the fourth surface 109 are not parallel to each other and are not perpendicular to the first surface 106. The above-mentioned changes in the shape of the body portion 101 cause a problem that the signal transmission characteristics of the electrical connector, in particular, the signal transmission characteristics in the high frequency band are deteriorated. In particular, when the length L1 and the length L2 do not coincide with each other in the horizontal cross-sectional shape, areas of inner surfaces of the pair of contact pins 10 facing each other do not coincide with each other. This area difference significantly deteriorates the signal transmission characteristic of the electric connector in the high-frequency band.

Further, in order to improve the signal transmission characteristics of the electric connector in the high frequency band, it is most preferable that the length L1 of the first surface 106 and the length L2 of the second surface 107 are equal to the length L3 of the third surface 108 and the length L4 of the fourth surface 109 (L1, L2=L3, L4). As shown in FIG. 3, corner portions in the punching surface (the corners of the first surface 106) are collapsed when the punching process is performed with respect to the metal plate. Thus, in view of the deterioration of the signal transmission characteristics of the electrical connector caused by the collapses of the corner portions due to the punching process, a design value of a width of the contact pin 10 in a direction (the Y direction) perpendicular to a punching direction (the X direction) (this width is referred to as “punching width”) needs to be 1.5 times or more of a thickness of the metal plate. Specifically, the design value of the width of the contact pin 10 in the Y direction (that is the “punching width”, and the length L2 of the second surface 107 in a state that the collapses of the corner portions in FIG. 3 do not occur) needs to be 1.5 times or more of a length in the X direction of the shape indicated by the dotted lines (that is, the “thickness of the metal plate”). As described above, in the case of the conventional art where the contact pin 10 is obtained by the punching process and the cutting process, the punching width of the contact pin 10 is restricted by the thickness of the metal plate. Therefore, it is impossible to make the length L1 of the first surface 106 and the length L2 of the second surface 107 equal to the length L3 of the third surface 108 and the length L4 of the fourth surface 109.

### RELATED ART DOCUMENT

### Patent Document

Patent document 1: Japanese Patent Application No. 2023-011653

### SUMMARY OF THE INVENTION

### Problems to be Solved by the Invention

The present disclosure has been made in view of the above-described conventional problems. Accordingly, it is a first object to obtain the pair of contact pins of the electrical connector without performing the punching process in which the metal plate is pressed and punched into a predetermined shape and with performing a pressing process with respect to a wire rod having a rectangular cross-sectional shape, thereby preventing the collapses of the corner portions of the body portion of each of the contact pins and preventing the difference between the length of the first surface and the length of the second surface of the body portion in the horizontal cross-sectional shape of the body portion from occurring for improving the signal transmission characteristics of the electrical connector.

Further, it is a second object of the present disclosure to obtain each of the contact pins of the electrical connector without performing the punching process in which the metal plate is pressed and punched into the predetermined shape and with performing the pressing process to the wire rod having the rectangular cross-sectional view, thereby setting the length of the first surface, the length of the second surface, the length of the third surface and the length of the fourth surface of the contact pin to lengths more suitable for improving the signal transmission characteristics for improving the signal transmission characteristics of the electrical connector.

### Means for Solving the Problems

The above objects are achieved by the present disclosures defined by the following (1) and (4).
(1) An electrical connector which can be coupled with a mating connector inserted from a tip side thereof, comprising:
a pair of contact pins; and
an insulating housing for containing the pair of contact pins therein in a state that the pair of contact pins are insulated from each other,
wherein each of the pair of contact pins includes a body portion having a rectangular cross-sectional shape,
wherein the body portion of each of the pair of contact pins includes:
an outer surface and an inner surface facing each other, and
a third surface and a fourth surface facing each other,
wherein the inner surfaces of the pair of contact pins face each other through a gap therebetween, and
wherein the body portion of each of the pair of contact pins further includes a recessed portion formed on the outer surface and a pair of protruding portions respectively protruding from portions of the third surface and the fourth surface adjacent to the recessed portion toward an outer side.
(2) A method of manufacturing each of a pair of contact pins used for an electrical connector which can be coupled with a mating connector inserted from a tip side thereof and includes the pair of contact pins and an insulating housing for containing the pair of contact pins therein in a state that the pair of contact pins are insulated from each other, the method comprising:
pressing both end portions of a wire rod having a rectangular cross-sectional shape to form the contact pin including:
   a body portion having a rectangular cross-sectional shape,
   a contact portion extending from one end portion of the body portion, and
   a terminal portion extending from another end portion of the body portion.
(3) An electrical connector which can be coupled with a mating connector inserted from a tip side thereof, comprising:
a pair of contact pins; and
an insulating housing for containing the pair of contact pins therein in a state that the pair of contact pins are insulated from each other,
wherein each of the pair of contact pins is formed from a wire rod having a rectangular cross-sectional shape,
wherein each of the pair of contact pins includes a body portion having a rectangular cross-sectional shape,
wherein opposite inner surfaces of the body portions of the pair of contact pins are flat surfaces, and
wherein each of the pair of contact pins further includes a recessed portion formed on a predetermined portion of an outer surface facing the inner surface of the body portion.
(4) A method of manufacturing each of a pair of contact pins used for an electrical connector which can be coupled with a mating connector inserted from a tip side thereof and includes the pair of contact pins and an insulating housing for containing the pair of contact pins therein in a state that the pair of contact pins are insulated from each other, the method comprising:
pressing both end portions of a wire rod having a rectangular cross-sectional shape to form the contact pin including:
   a body portion having a rectangular cross-sectional shape,
   a contact portion extending from one end portion of the body portion, and
   a terminal portion extending from another end portion of the body portion,
wherein opposite inner surfaces of the body portions of the pair of contact pins are flat surfaces, and
wherein each of the pair of contact pins further includes a recessed portion formed on a predetermined portion of an outer surface facing the inner surface of the body portion.

### Effects of the Invention

In the present disclosure, each of the contact pins is obtained by performing the pressing process with respect to the wire rod having the rectangular cross-sectional shape. Thus, unlike a contact pin obtained by performing a punching process with respect to a metal plate, corner portions of a body portion of the contact pin are not collapsed during the manufacturing process for the contact pin. Therefore, it is possible to prevent a difference between a length of a first surface and a length of a second surface of the body portion in the cross-sectional shape of the body portion from occurring, and thereby it is possible to improve signal transmission characteristics of the electrical connector.

Further, in the present disclosure, each of the contact pins is obtained by performing the pressing process with respect to the wire rod having the rectangular cross-sectional shape. Thus, unlike the contact pin obtained by performing the punching process with respect to the metal plate, a punching width of the contact pin is not restricted by a thickness of the metal plate and thus it is possible to freely set the punching width of the contact pin within the scope of a thickness and a cross-sectional shape of a procurable wire rod. Therefore, it is possible to form the contact pin so that the length of the first surface, the length of the second surface, a length of a third surface, and a length of a fourth surface of the contact pin are substantially equal to each other, thereby improving the signal transmission characteristics of the electrical connector.

Further, in the present disclosure, the opposite inner surfaces of the body portions of the pair of contact pins are the flat surfaces. With this configuration, it is possible to keep a separation distance between the pair of contact pins constant. By keeping the separation distance between the pair of contact pins constant, it is possible to stabilize the signal transmission characteristics of the electrical connector.

### BRIEF DESCRIPTION OF THE DRAWINGS

FIG. 1 is a perspective view showing a housing and a contact pin typically used in a conventional electrical connector.

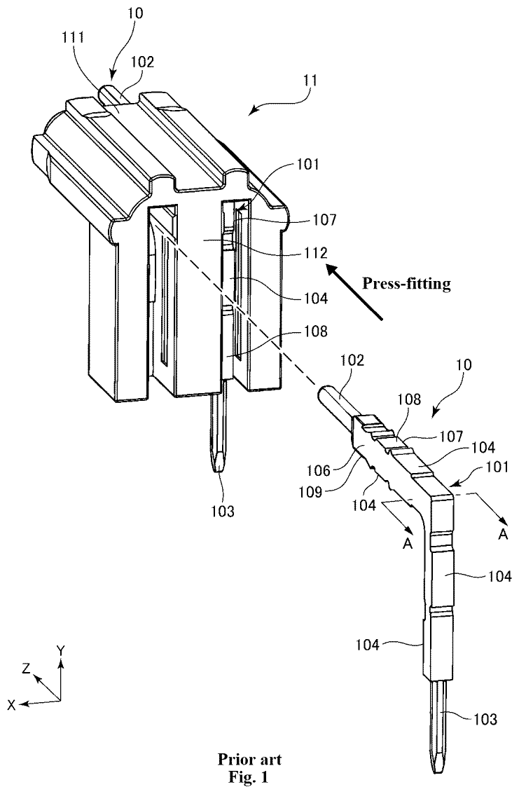

FIG. 2 is a planar view showing a work in process of the contact pin shown in FIG. 1.

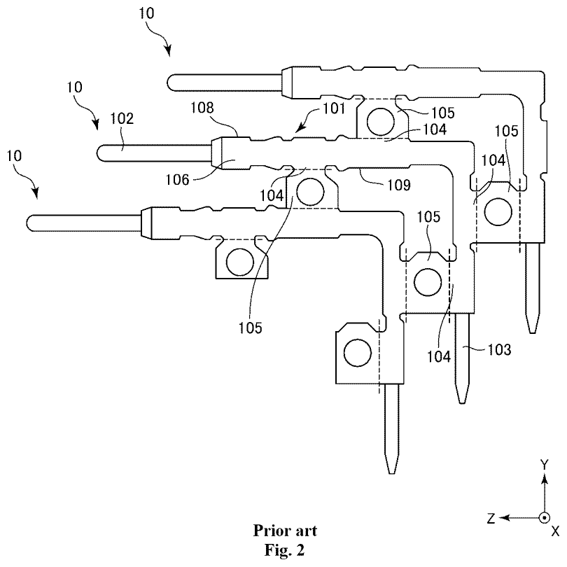

FIG. 3 is a cross-sectional view of a body portion of the contact pin taken along an A-A line shown in FIG. 1.

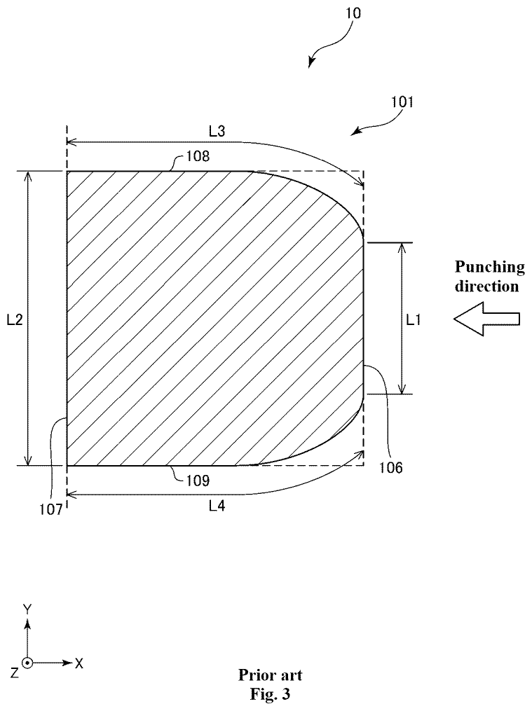

FIG. 4 is a perspective view showing an electrical connector of the present disclosure, a circuit board on which the electrical connector of the present disclosure should be mounted, and a mating connector to be coupled with the electrical connector of the present disclosure.

FIG. 5 is a perspective view of the electrical connector shown in FIG. 4.

FIG. 6 is another perspective view showing the electrical connector shown in FIG. 4 viewed from another angle.

FIG. 7 is a cross-sectional view along a YZ plane including an insertion hole of a housing of the electric connector shown in FIG. 4.

FIG. 8 is an exploded perspective view of the electrical connector shown in FIG. 4.

FIG. 9 is a perspective view of a contact pin.

FIG. 10 is a XY planar view of a body portion of the contact pin taken along a B-B line shown in FIG. 9.

FIG. 11 is a perspective view of the housing.

FIG. 12 is a perspective view for explaining a press-fitting of the contact pin into the housing.

FIG. 13 is a perspective view of a shell.

FIG. 14 is another perspective view of the shell viewed from another angle.

FIG. 15 shows a XZ plane cross-sectional view of the electrical connector taken along a C-C line shown in FIG. 5 and a partial enlarged view of an engagement protrusion of the housing and an engagement protrusion of the shell.

FIG. 16 is a perspective view of a cover.

FIG. 17 is another perspective view of the cover viewed from another angle.

FIG. 18 is a flowchart showing a method of manufacturing the electrical connector of the present disclosure.

FIG. 19 is a flowchart showing a method of manufacturing the contact pin of the electrical connector of the present disclosure.

FIG. 20 is a cross-sectional view taken along a YZ plane including the contact pin in a state that the electric connector and the mating connector are coupled with each other.

### DETAILED DESCRIPTION

Hereinafter, description will be given to an electrical connector of the present disclosure based on a preferred embodiment shown in the accompanying drawings. In this regard, the drawings referenced in the following description are schematic views prepared for explaining the present disclosure. A dimension (such as a length, a width and a thickness) of each component shown in the drawings is not necessarily identical to an actual dimension. Further, the same reference numbers are used throughout the drawings to refer to the same or like elements. In the following description, a positive direction of the Z axis in each figure may be referred to as a “tip side” or a “front side”, a negative direction of the Z axis in each figure may be referred to as a “base side” or a “rear side”, a positive direction of the Y axis in each figure may be referred to as an “upper side”, a negative direction of the Y axis in each figure may be referred to as a “lower side”, a positive direction of the X axis in each figure may be referred to as a “near side”, and a negative direction of the X axis may be referred to as a “far side” in each figure. In addition, the Z direction may be referred to as an “insertion and extraction direction of the mating connector”, the Y direction may be referred to as a “height direction”, and the X direction may be referred to as a “width direction”.

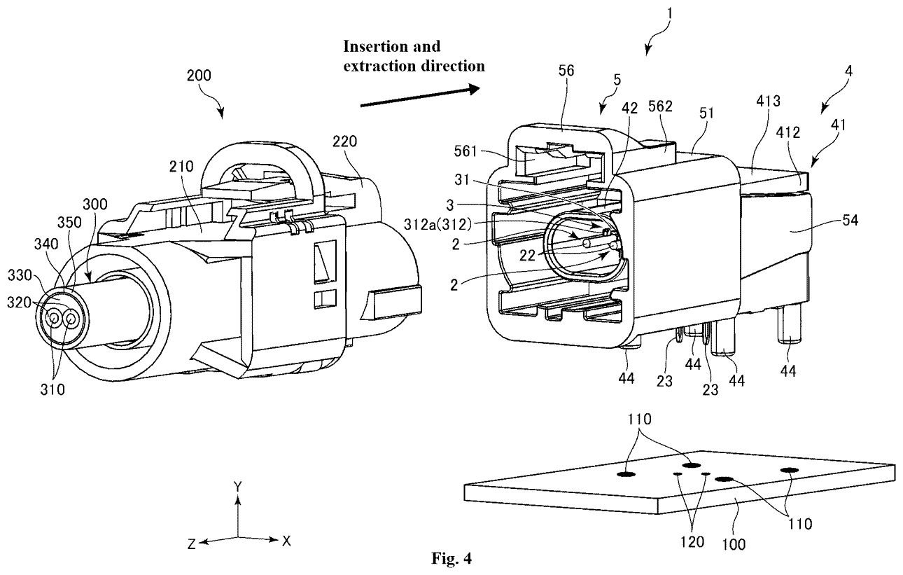

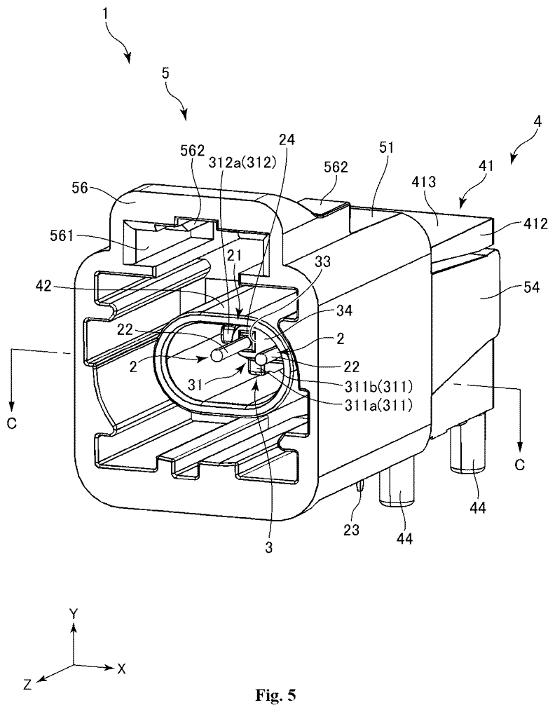

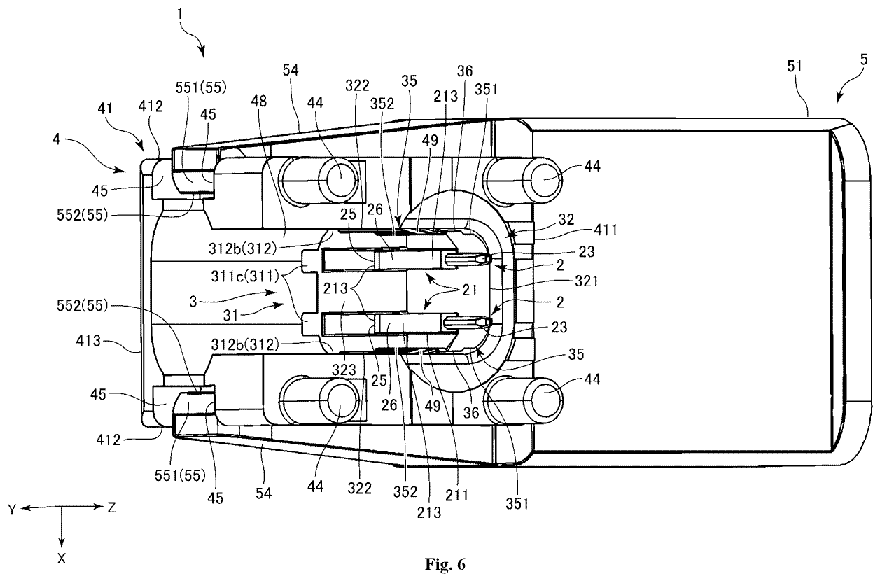

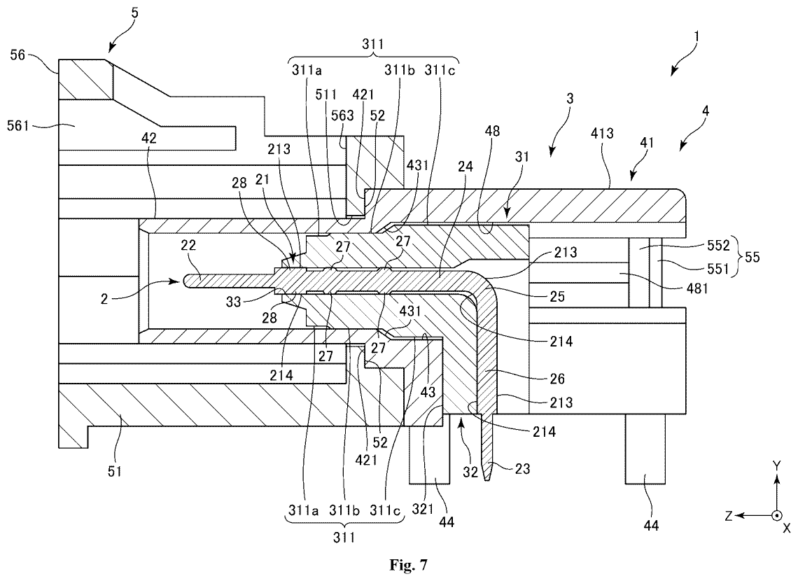

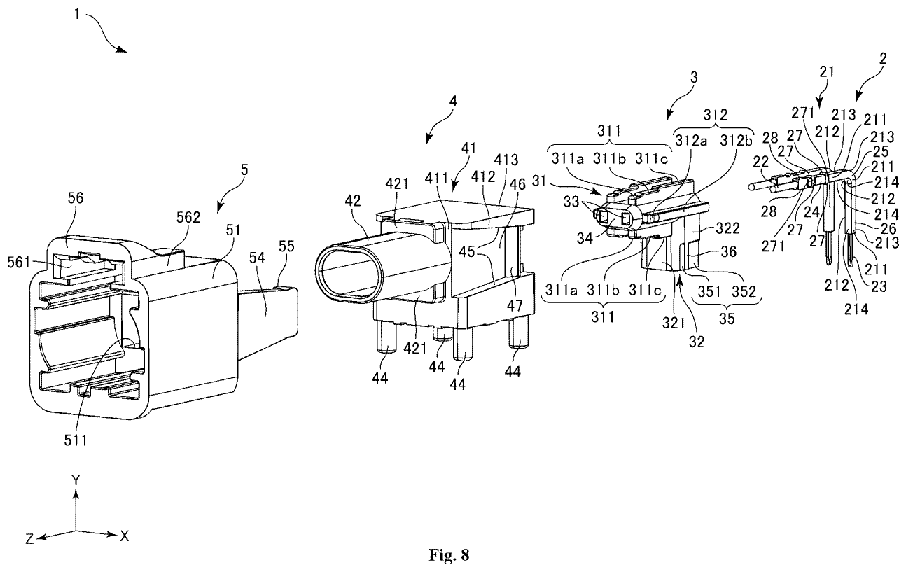

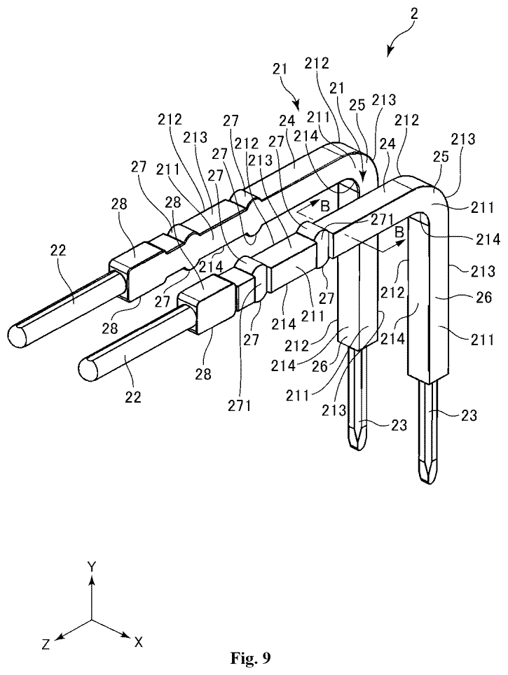

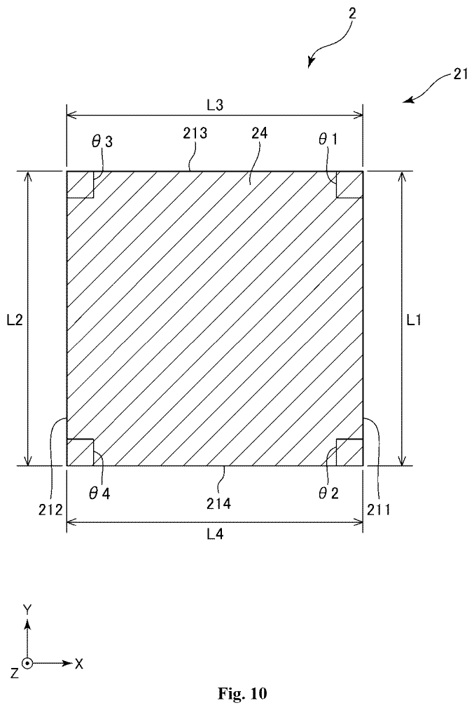

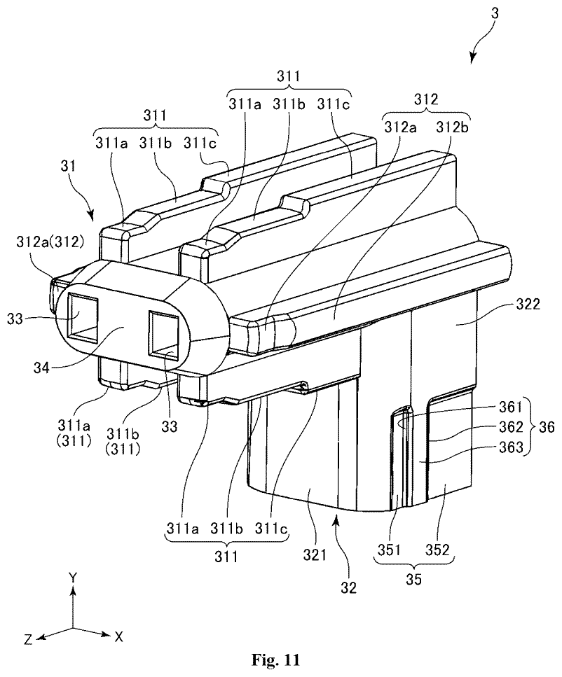

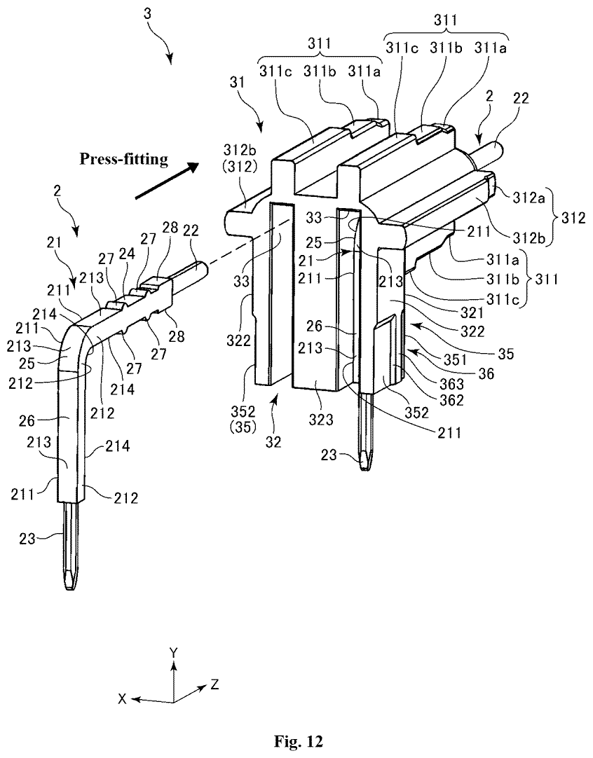

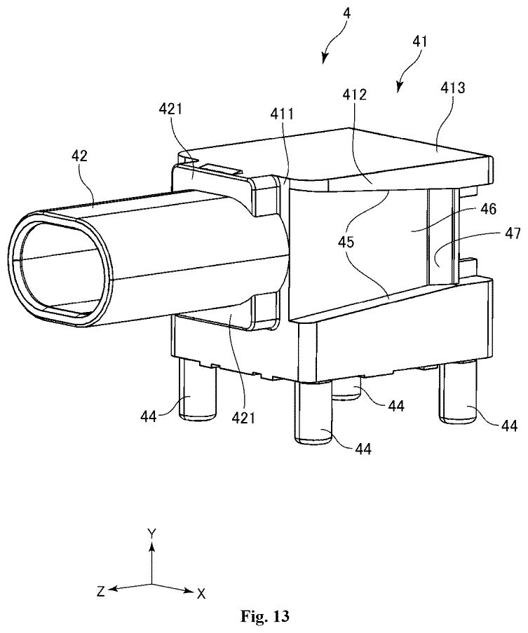

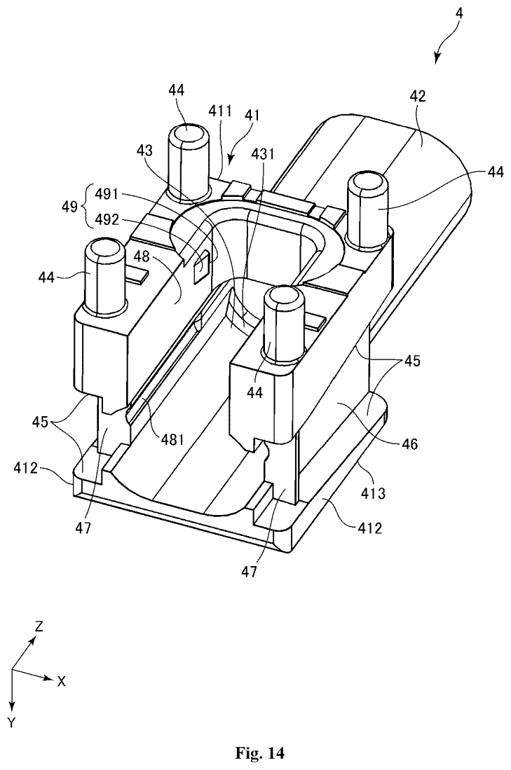

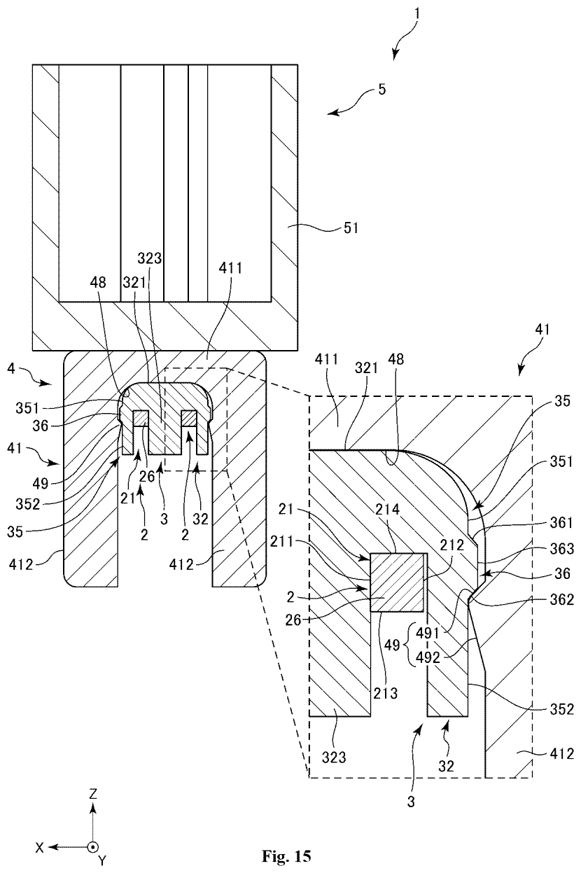

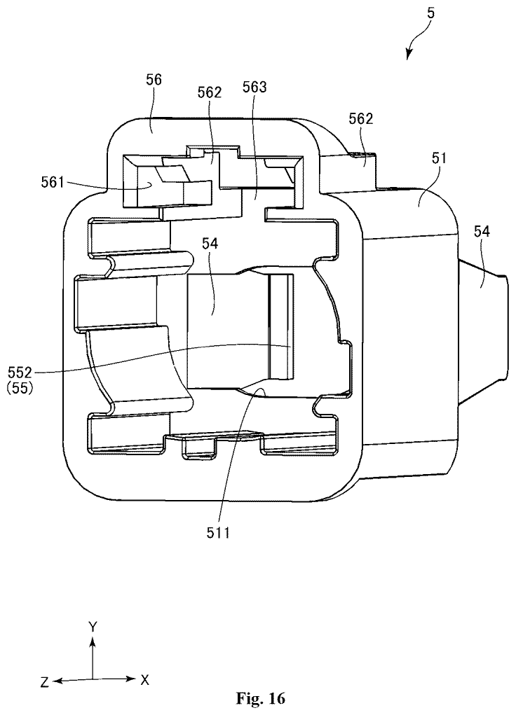

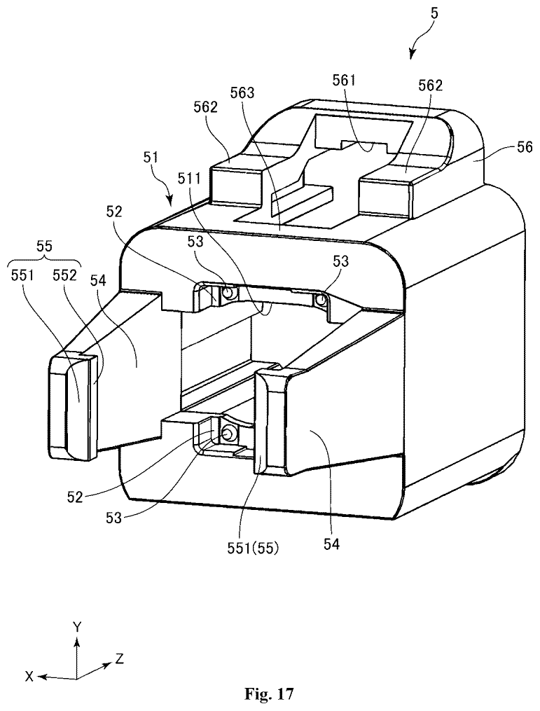

FIG. 4 is a perspective view showing an electrical connector of the present disclosure, a circuit board on which the electrical connector of the present disclosure should be mounted, and a mating connector to be coupled with the electrical connector of the present disclosure. FIG. 5 is a perspective view of the electrical connector shown in FIG. 4. FIG. 6 is another perspective view showing the electrical connector shown in FIG. 4 viewed from another angle. FIG. 7 is a cross-sectional view along a YZ plane including an insertion hole of a housing of the electric connector shown in FIG. 4. FIG. 8 is an exploded perspective view of the electrical connector shown in FIG. 4. FIG. 9 is a perspective view of a contact pin. FIG. 10 is a XY planar view of a body portion of the contact pin taken along a B-B line shown in FIG. 9. FIG. 11 is a perspective view of the housing. FIG. 12 is a perspective view for explaining a press-fitting of the contact pin into the housing. FIG. 13 is a perspective view of a shell. FIG. 14 is another perspective view of the shell viewed from another angle. FIG. 15 shows a XZ plane cross-sectional view of the electrical connector taken along a C-C line shown in FIG. 5 and a partial enlarged view of an engagement protrusion of the housing and an engagement protrusion of the shell. FIG. 16 is a perspective view of a cover. FIG. 17 is another perspective view of the cover viewed from another angle.

As shown in FIG. 4, an electrical connector 1 of the present disclosure is a receptacle connector to be mounted on a circuit board 100 provided in an arbitrary device. When a mating connector (a plug connector) 200 attached to a tip end portion of a coaxial cable 300 is inserted into the electrical connector 1 from the tip side to couple the electrical connector 1 with the mating connector 200, an electrical connection between the coaxial cable 300 and the circuit board 100 is provided through the electrical connector 1 and the mating connector 200.

The coaxial cable 300 has a structure in which a pair of core wires (center conductors) 310 and a pair of inner insulator layers 320 respectively covering the pair of core wires 310 are concentrically arranged and further a first outer insulator layer 330 covering the pair of inner insulator layers 320, an outer conductor layer (a braid layer) 340 covering the first outer insulator layer 330 and a second outer insulator layer 350 further covering the outer conductor layer 340 are concentrically arranged. Although this matter is omitted in FIG. 4, a base end portion of the coaxial cable 300 is connected to another device differing from the device including the circuit board 100. Thus, when the electrical connector 1 and the mating connector 200 are coupled with each other, it becomes possible to perform a signal communication between the device including the circuit board 100 and the other device through the coaxial cable 300. The device including the circuit board 100 is typically an ECU (Electronic Control Unit) for controlling operations of a vehicle. The other device to which the base end portion of the coaxial cable 300 is connected is typically an in-vehicle device such as an in-vehicle network communication equipment (for example, which is used for an in-vehicle Ethernet), a car navigation equipment, a car audio, an in-vehicle camera, an in-vehicle GPS, an in-vehicle TV and an in-vehicle radio. By coupling the electrical connector 1 and the mating connector 200 with each other, it becomes possible to perform a high-speed signal communication between the in-vehicle device and the ECU through the coaxial cable 300 containing the two core wires (center conductors) 310. Although the electrical connector 1 is a 2-pin connector for providing a coaxial connection with the coaxial cable 300 containing the two core wires 310 in the illustrated aspect, the electrical connector 1 may be a multi-pin connector such as a 4-pin connector (for example, a high-speed data (HSD) connector) for providing coaxial connections with two or more pairs of coaxial cables 300 each containing two or more pairs of core wires 310. Hereinafter, the electrical connector 1 will be described with assuming that the electrical connector 1 is the 2-pin connector for providing the coaxial connection with the coaxial cable 300 containing the two core wires 310.

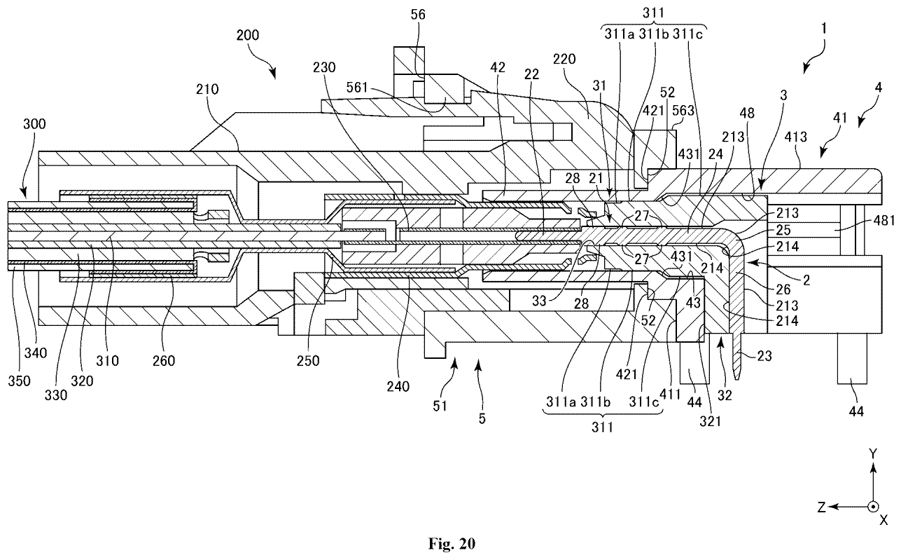

As shown in FIGS. 5 to 8, and in particular FIG. 8, the electrical connector 1 includes a pair of contact pins 2 which should respectively contact with corresponding contact pins 230 (see FIG. 20) of the mating connector 200, a housing 3 for holding the pair of contact pins 2, a shell 4 which is formed from metal material and which holds the housing 3, and a cover 5 attached to a tip side portion of the shell 4.

Each of the contact pins 2 is an L-shaped member made of conductive material such as a copper alloy. Each of the contact pins 2 can be obtained by performing a pressing process and a bending process with respect to a wire rod having a rectangular cross-sectional shape. Each of the contact pins 2 has a function of contacting with a corresponding contact pin 230 of the mating connector 200 when the electrical connector 1 and the mating connector 200 are coupled with each other to provide an electrical connection between the mating connector 200 and the electrical connector 1. The pair of contact pins 2 are respectively press-fitted into a pair of insertion holes 33 (see FIG. 8) formed in a cylindrical portion 31 of the housing 3. FIG. 9 shows the pair of contact pins 2 shown in FIG. 8. Since the two contact pins 2 have the same configuration as each other, the contact pin 2 located on the +X direction side will be described in detail as a representative.

As shown in FIG. 9, the contact pin 2 includes a body portion 21 having a rectangular cross-sectional shape, a contact portion 22 extending from a tip end portion of the body portion 21 and having a substantially circular cross-sectional shape (more specifically, a circular shape in which a +Y direction side portion and a −Y direction side portion are cut out), and a terminal portion 23 extending from a base end portion of the body portion 21 and having a substantially hexagonal cross-sectional shape. The body portion 21 includes a horizontally extending portion 24 linearly extending in the insertion and extraction direction of the mating connector 200 (the Z direction), a connecting portion 25 bending from a base end portion of the horizontally extending portion 24 toward the lower side, a downwardly extending portion 26 linearly extending from a lower end portion of the connecting portion 25 toward the lower side, two pairs of protruding portions 27 extending from the horizontally extending portion 24 in the height direction of the contact pin 2 (the Y direction or the outer side) perpendicular to the insertion and extraction direction of the mating connector 200 (the Z direction), and a pair of tip protruding portions 28 respectively extending from a third surface 213 and a fourth surface 214 of a tip side portion of the horizontally extending portion 24 in the height direction of the contact pin 2.

Each of the horizontally extending portion 24, the connecting portion 25 and the downwardly extending portion 26 includes a first surface 211 and a second surface 212 extending with being spaced apart from each other, and a third surface 213 and a fourth surface 214 extending with being spaced apart from each other and perpendicular to the first surface 211 and the second surface 212. The first surface 211 of each of the horizontally extending portion 24, the connecting portion 25 and the downwardly extending portion 26 is a +X direction side surface perpendicular to the X direction. The second surface 212 of each of the horizontally extending portion 24, the connecting portion 25 and the downwardly extending portion 26 is a −X direction side surface perpendicular to the X direction. The third surface 213 of the horizontally extending portion 24 is a +Y direction side surface perpendicular to the Y direction and the fourth surface 214 of the horizontally extending portion 24 is a −Y direction side surface perpendicular to the Y direction. The third surface 213 of the connecting portion 25 is a curved surface located on the outer side of a center of curvature of the connecting portion 25 and the fourth surface 214 of the connecting portion 25 is a curved surface located on the inner side of the center of curvature of the connecting portion 25. The third surface 213 of the downwardly extending portion 26 is a −Z direction side surface perpendicular to the Z direction and the fourth surface 214 of the downwardly extending portion 26 is a +Z direction side surface perpendicular to the Z direction.

FIG. 10 shows a cross-sectional shape of the horizontally extending portion 24 (the cross-sectional shape taken along a B-B line in FIG. 9). Since cross-sectional shapes of the connecting portion 25 and the downwardly extending portion 26 have the same configurations as the configuration of the cross-sectional shape of the horizontally extending portion 24, the cross-sectional shape of the horizontally extending portion 24 will be described in detail with reference to FIG. 10 as a representative. As shown in FIG. 10, the cross-sectional shape of the horizontally extending portion 24 is rectangle, more specifically oblong or square. In FIG. 10, a length of the first surface 211 in the height direction (the Y direction) is indicated by “L1”, a length of the second surface 212 in the height direction is indicated by “L2”, a length of the third surface 213 in the width direction (the X direction) is indicated by “L3”, and a length of the fourth surface 214 in the width direction is indicated by “L4”. The first surface 211 and the second surface 212 are substantially parallel to each other. The third surface 213 and the fourth surface 214 are substantially parallel to each other. Further, the length L1 of the first surface 211 and the length L2 of the second surface 212 are substantially equal to each other. Specifically, in the cross-sectional shape of the horizontally extending portion 24, a ratio (L1/L2 or L2/L1) of the length L1 of the first surface 211 and the length L2 of the second surface 212 satisfies the relationship of 0.9 to 1.1. Further, in the cross-sectional shape of the horizontally extending portion 24, the length L3 of the third surface 213 and the length L4 of the fourth surface 214 are substantially equal to each other. Specifically, in the cross-sectional shape of the horizontally extending portion 24, a ratio (L3/L4 or L4/L3) of the length L3 of the third surface 213 and the length L4 of the fourth surface 214 satisfies a relationship of 0.9 to 1.1.

Over an entire length of the body portion 21 (in all of the horizontally extending portion 24, the connecting portion 25, and the lower extending portion 26), the relationship of the ratio of the length L1 of the first surface 211 and the length L2 of the second surface 212 and the relationship of the ratio of the length L3 of the third surface 213 and the length L4 of the fourth surface 214 are satisfied. Each of an angle θ1 of a corner (a first corner) formed by the first surface 211 and the third surface 213, an angle θ2 of a corner (a second corner) formed by the first surface 211 and the fourth surface 214, an angle θ3 of a corner (a third corner) formed by the second surface 212 and the third surface 213, and an angle θ4 of a corner (a fourth angle) formed by the second surface 212 and the fourth surface 214 is substantially a 90-degree angle, and more specifically, each of the angles θ1, θ2, θ3, θ4 falls within the range of 85 to 95 degrees.

Since each of the contact pins 2 of the present disclosure is obtained by performing the pressing process and the bending process with respect to the wire rod having the rectangular cross-sectional shape as described above, corner portions (the first corner, the second corner, the third corner and the fourth corner) of the body portion 21 (the horizontally extending portion 24, the connecting portion 25 and the downwardly extending portion 26) are not collapsed in the manufacturing process for the contact pin 2, and thereby there are no changes or significantly slight changes in the shape of the body portion 21 unlike the conventional contact pin obtained by performing the punching process and the cutting process with respect to the metal plate described in the background art. In particular, in each of the contact pins 2 of the present disclosure, the length L1 of the first surface 211 and the length L2 of the second surface 212 are substantially equal, and the third surface 213 and the fourth surface 214 are parallel to each other and perpendicular to the first surface 211 and the second surface 212 in the cross-sectional shape of the body portion 21. According to the present disclosure unlike the conventional art, it is possible to prevent a difference between the length L1 of the first surface 211 and the length L2 of the second surface 212 from occurring in the manufacturing process for the contact pin 2, and thus it is possible to improve signal transmission characteristics of the electrical connector 1.

Further, as described above, the corner portions in the punched surface are collapsed when the punching process is performed on the metal plate. Thus, if the contact pin is obtained by performing the punching process and the cutting process as is the case of the conventional art, a width of the contact pin in a direction perpendicular to a punching direction (this width is referred to as a “punching width”) is restricted by a thickness of the metal plate. Specifically, in consideration of the deterioration in the signal transmission characteristics of the electrical connector caused by the collapses of the corner portions due to the above-described punching process, it is necessary to set the punching width of the contact pin be 1.5 times or more of the thickness of the metal plate. For example, it is assumed that the contact pin 2 is obtained by the conventional method in which the punching process and the cutting process are performed. In this case, when the X direction in FIG. 10 is defined as the punching direction, the lengths L1, L2 of the contact pin 2 in the Y direction (that is, the “punching width”) needs to be 1.5 times or more of the lengths L3, L4 of the contact pin 2 in the X direction (that is, the “thickness of the metal plate”). However, there is a case that it is desired to make the lengths L1, L2 of the contact pin 2 in the Y direction less than 1.5 times of the lengths L3, L4 of the contact pin 2 in the X direction in order to improve the signal transmission characteristics of the electric connector 1.

As described above, each of the contact pins 2 of the present disclosure is obtained by performing the pressing process and the bending process with respect to the wire rod having the rectangular cross-sectional shape. Thus, the lengths L1, L2 of the contact pin 2 in the Y direction are not restricted by the lengths L3, L4 of the contact pin 2 in the X direction. The lengths L1, L2, L3, L4 of the contact pin 2 depend on the thickness and the cross-sectional shape of the wire rod to which the pressing process and the bending process should be performed. In addition, it is possible to procure a variety of wire rods having various thicknesses and cross-sectional shapes in the marketplace. Thus, there is no restriction described above with respect to the lengths L1, L2, L3, L4 of the contact pin 2 of the present disclosure, and thus it is possible to freely set the lengths L1, L2, L3, L4 of the contact pin 2 within the scope of the thickness and the cross-sectional shape of the wire rod which can be procured. Therefore, according to the present disclosure, it is possible to make the lengths L1, L2 of the contact pin 2 in the Y direction less than 1.5 times of the lengths L3, L4 of the contact pin 2 in the X direction. In the illustrated aspect, the contact pin 2 is formed so that the lengths L1, L2 are less than 1.5 times of the lengths L3, L4. Specifically, the contact pin 2 is formed so that the lengths L1, L2, L3, L4 of the contact pin 2 are substantially equal to each other (e.g., differences between them are fall within ±10%). With this configuration, it is possible to improve the signal transmission characteristics of the electrical connector 1.

Referring back to FIG. 9, opposite inner surfaces of the body portions 21 of the pair of contact pins 2 (the second surface 212 of the contact pin 2 located on the +X direction side and the first surface 211 of the contact pin 2 located on the −X direction side) are flat surfaces perpendicular to the X direction. With this configuration, it is possible to keep a separation distance between the pair of contact pins 2 in the X direction constant. By keeping the separation distance between the pair of contact pins 2 in the X direction constant, it is possible to stabilize the signal transmission characteristics of the electrical connector 1. Further, in the electric connector 1 of the present disclosure, the length L2 of the second surface 212 of the contact pin 2 located on the +X direction side and the length L1 of the first surface 211 of the contact pin 2 located on the −X direction side are substantially equal to each other in the cross-sectional shape of the body portion 21. Thus, areas of the opposite inner side surfaces (the second surface 212 of the contact pin 2 located on the +X direction side and the first surface 211 of the contact pin 2 located on the −X direction side) of the pair of contact pins 2 facing each other are substantially equal to each other. As described in the section of the background art, inconsistency in the areas of the opposite inner surfaces of the pair of contact pins 2 deteriorates the signal transmission characteristics of the electrical connector 1, in particular, the signal transmission characteristics of the electric connector 1 in the high frequency band. In the contact pin 2 of the present disclosure, the length L1 of the first surface 211 and the length L2 of the second surface 212 are substantially equal to each other, and the areas of the opposite inner surfaces of the pair of contact pins 2 are also substantially equal to each other, so that it is possible to improve the signal transmission characteristics of the electric connector 1, in particular, the signal transmission characteristics of the electric connector 1 in the high frequency band.

The contact portion 22 is a substantially columnar portion linearly extending from the tip end portion of the horizontally extending portion 24 toward the tip side. More specifically, the contact portion 22 has a substantially columnar shape in which the +Y direction side portion and the −Y direction side portion are cut out so as to be parallel to the XZ plane. Further, as shown in FIG. 5, in a state that the contact pin 2 is held by the housing 3, the contact portion 22 protrudes from the cylindrical portion 31 of the housing 3 toward the tip side and exposed toward the outside. When the electrical connector 1 and the mating connector 200 are coupled with each other, the contact portion 22 contacts with the corresponding contact pin 230 of the mating connector 200 to provide the electrical connection between the mating connector 200 and the electrical connector 1 (see FIG. 20). The contact portion 22 is formed in the substantially columnar shape by performing the pressing process with respect to the wire rod having the rectangular cross-sectional shape. In the pressing process, a pair of molds are pressed against the wire rod from both sides (for example, from the side of the first surface 211 and the side of the second surface 212). Thus, the cross-sectional shape of the contact portion 22 is substantially circular.

Referring back to FIG. 9, the terminal portion 23 is a substantially pyramidal portion formed so as to protrude from the lower end portion of the downwardly extending portion 26 of the body portion 21 toward the lower side. In the state that the contact pin 2 is held by the housing 3, the terminal portion 23 extends from the contact pin 2 toward the lower side and is exposed toward the outside. The terminal portion 23 should be connected to a corresponding terminal 120 (see FIG. 4) of the circuit board 100. The terminal portion 23 is formed in a substantially pyramidal shape (illustrated form) by performing the pressing process with respect to the wire rod having the rectangular cross-sectional shape. In the pressing process, a pair of molds are pressed against the wire rod from both sides (for example, the side of the first surface 211 and the side of the second surface 212) to form the terminal portion 23 into the substantially pyramidal shape.

The horizontally extending portion 24 is a plate-like portion linearly extending in the insertion and extraction direction of the mating connector 200 (the Z direction). When the pair of contact pins 2 are respectively press-fitted into the pair of insertion holes 33 of the housing 3, each of the horizontally extending portions 24 is located in the cylindrical portion 31 of the housing 3. In particular, as shown in FIG. 7, the horizontally extending portion 24 is held in the insertion hole 33, and thereby the contact pin 2 is held by the housing 3.

Referring back to FIG. 9, the connecting portion 25 is an L-shaped portion for connecting between the horizontally extending portion 24 and the downwardly extending portion 26. The connecting portion 25 is bent from the base end portion of the horizontally extending portion 24 toward the lower side. One end portion (an end portion directed to the +Z direction side) of the connecting portion 25 is continuous with the base end portion of the horizontally extending portion 24. Another end portion (an end portion directed to the −Y direction side) of the connecting portion 25 is continuous with an upper end portion of the downwardly extending portion 26. The connecting portion 25 is formed by performing the bending process with respect to the wire having the rectangular cross-sectional shape. The downwardly extending portion 26 is a plate-like portion linearly extending from the lower end portion of the connecting portion 25 toward the lower side. As shown in FIG. 7, in the state that the contact pin 2 is held by the housing 3, the downwardly extending portion 26 is located in a downwardly extending portion 32 of the housing 3.

The two pairs of protruding portions 27 protrude from the third surface 213 and the fourth surface 214 of the horizontally extending portion 24 in the height direction of the contact pin 2 (the Y direction or the outside). The upper two protruding portions 27 protrude from the third surface 213 toward the +Y direction side. The lower two protruding portions 27 protrude from the fourth surface 214 toward the −Y direction side. The upper protruding portion 27 and the lower protruding portion 27 of each pair are formed at positions facing each other through the horizontally extending portion 24. Each of the two pairs of protruding portions 27 is pressed by an inner surface of the insertion hole 33 in the state that the contact pin 2 is press-fitted in the insertion hole 33 of the housing 3. Thus, each of the two pairs of protruding portions 27 has a function of increasing holding force for the contact pin 2 in the insertion hole 33. In the illustrated aspect, the two pairs of protruding portions 27 are formed on the third surface 213 and the fourth surface 214, but the number and the positions of the protruding portions 27 formed on the third surface 213 and the fourth surface 214 are not limited thereto. One, two, three, five or more protruding portions 27 may be formed on the third surface 213 or the fourth surface 214. Since each of the pairs of the protruding portions 27 has the same configuration as each other, the pair of protruding portions 27 located on the +Z direction side will be described in detail as a representative.

Each of the protruding portions 27 has a semicircular shape protruding toward the outer side (the Y direction) in a planar view from the X direction. This shape is obtained by performing the pressing process with respect to the wire rod having the rectangular cross-sectional shape. In the pressing process, a mold is pressed against one side surface of the wire rod. Specifically, for the contact pin 2 located on the +X direction side in FIG. 9, the mold is pressed against a predetermined portion of the first surface 211 of the contact pin 2 in the pressing process to form the pair of protruding portions 27. For the contact pin 2 located on the −X direction side, the mold is pressed against a predetermined portion of the second surface 212 (the −X direction side surface) of the contact pin 2 to form the pair of protruding portions 27.

In the case of the contact pin 2 located on the +X direction side in FIG. 9, a recessed portion 271 is formed on the predetermined portion of the first surface 211 (the outer surface in the X direction) onto which the mold is pressed to form the pair of protruding portions 27, and a portion of the first surface 211 (the outer surface in the X direction) where the recessed portion 271 is formed is positioned more to the −X direction side than other portions of the first surface 211. On the other hand, the recessed portion 271 is not formed on a portion of the second surface 212 (the inner surface in the X direction opposed to the other contact pin 2) corresponding to the predetermined portion of the first surface 211 onto which the mold is pressed, and thus the portion of the second surface 212 is a flat surface which is continuous with other portions of the second surface 212. Similarly, for the contact pin 2 located on the −X direction side of FIG. 9, the recessed portion 271 is formed on the predetermined portion of the second surface 212 on which the mold is pressed. Thus, a portion of the second surface 212 where the recessed portion 271 is formed (the outer surface in the X direction) is positioned more to the +X direction side than other portions of the second surface 212. Further, the recessed portion 271 is not formed on a portion of the first surface 211 corresponding to the predetermined portion of the second surface 212, and thus the portion of the first surface 211 is a flat surface which is continuous with other portions of the first surface 211. In both of the contact pin 2 located on the +X direction side and the contact pin 2 located on the X direction side in FIG. 9, the pair of protruding portions 27 protrude from portions of both side surfaces in the Y direction (the third surface 213 and the fourth surface 214) adjacent to the recessed portion 271 toward the outer side so as to correspond to the recessed portion 271.

Since each of the protruding portions 27 has the same configuration as each other, the upper protruding portion 27 formed on the third surface 213 of the horizontally extending portion 24 will be described in detail as a representative. The upper protruding portion 27 is a semicircular protrusion in the planar view from the X direction and protrudes from the third surface 213 toward the upper side. An outer surface (a surface on the +Y direction side) of the upper protruding portion 27 is a curved surface protruding toward the upper side. Both side surfaces (surfaces in the X direction) of the upper protruding portion 27 are flat surfaces perpendicular to the X direction. In the state that the contact pin 2 is press-fitted into the insertion hole 33 of the housing 3, the upper protruding portion 27 contacts with the inner surface of the insertion hole 33 (see FIG. 7).

Referring back to FIG. 9, the pair of tip protruding portions 28 respectively protrude from the third surface 213 and the fourth surface 214 of the tip side portion of the horizontally extending portion 24 in the height direction of the contact pin 2 (the Y direction or the outer side). The pair of tip protruding portions 28 are formed by performing the pressing process with respect to the wire rod having the rectangular cross-sectional shape. In the pressing process, a mold is pressed against the wire rod from four sides (both lateral sides, upper side, and lower side). Since each of the tip protruding portions 28 has the same configuration as each other, the upper tip protruding portion 28 formed on the third surface 213 of the horizontally extending portion 24 will be described in detail as a representative. The tip protruding portion 28 is a protrusion protruding from the third surface 213 toward the upper side and having a rectangular shape in the planar view from the X direction. An outer surface (a surface on the +Y direction side) of the tip protruding portion 28 is a flat surface perpendicular to the Y direction. Both side surfaces (surfaces in the X direction) of the tip protruding portion 28 are flat surfaces perpendicular to the X direction.

The above-described contact pin 2 is press-fitted into the insertion hole 33 of the housing 3 and held by the housing 3. The housing 3 is made of clastic insulating material such as resin material (for example, liquid crystal polymer (LCP). As shown in FIGS. 11 and 12, the housing 3 includes the cylindrical portion 31 extending in the insertion and extraction direction of the mating connector 200, and the downwardly extending portion 32 extending from a base end portion of the cylindrical portion 31 toward the lower side.

As shown in FIG. 11, the cylindrical portion 31 is a cylindrical portion linearly extending in the insertion and extraction direction of the mating connector 200 (the Z direction). The cylindrical portion 31 has a rectangular planar shape with rounded corners in a planar view viewed from the Z direction. In the planar view viewed from the Z direction, a width-direction (X-direction) length of the cylindrical portion 31 is larger than a height-direction (Y-direction) length of the cylindrical portion 31. An upper surface and a lower surface of the cylindrical portion 31 are flat surfaces spaced apart from each other and extending in the insertion and extraction direction of the mating connector 200. Both X-direction side surfaces of the cylindrical portion 31 are curved surfaces spaced apart from each other and extending in the insertion and extraction direction of the mating connector 200. An outer diameter of the cylindrical portion 31 is slightly smaller than an inner diameter of an insertion hole 43 formed in a body portion 41 of the shell 4.

The cylindrical portion 31 includes four first pressing ribs 311, a pair of second pressing ribs 312, the pair of insertion holes 33, and a wall portion 34. The four first pressing ribs 311 are located on the upper surface and the lower side surface of the cylindrical portion 31 and extend in the insertion and extraction direction of the mating connector 200. The pair of second pressing ribs 312 are respectively located on both X-direction side surfaces of the cylindrical portion 31 and extend in the insertion and extraction direction of the mating connector 200. The pair of insertion holes 33 pass through the cylindrical portion 31 in the insertion and extraction direction of the mating connector 200. The wall portion 34 partitions between the pair of insertion holes 33.

The four first pressing ribs 311 are protruding portions protruding from an outer peripheral surface of the cylindrical portion 31 toward the outer side. The four first pressing ribs 311 are formed in order to prevent the contact pins 2 from being respectively shifted toward the base side in the insertion holes 33 of the housing 3 or from being respectively removed from the insertion holes 33, and to prevent the housing 3 from being removed from the cylindrical portion 42 and the insertion hole 43 of the shell 4. The four first pressing ribs 311 are formed on the upper surface and the lower surface of the cylindrical portion 31 at positions respectively corresponding to the two pairs of protruding portions 27 of the pair of contact pins 2, and linearly extending in the insertion and extraction direction of the mating connector 200 (the Z direction). Two of the four first pressing ribs 311 are located on the upper surface of the cylindrical portion 31, and the remaining two of the four first pressing ribs 311 are located on the lower surface of the cylindrical portion 31. The upper two of the first pressing ribs 311 respectively face the lower two of the first pressing ribs 311 through the pair of insertion holes 33 of the cylindrical portion 31. The upper two of the first pressing ribs 311 are spaced apart from each other on the upper surface of the cylindrical portion 31. The lower two of the first pressing ribs 311 are spaced apart from each other on the lower surface of the cylindrical portion 31.

Although the four first pressing ribs 311 are formed so that the upper two of the first pressing ribs 311 on the upper surface of the cylindrical portion 31 and the lower two of the first pressing ribs 311 on the lower surface of the cylindrical portion 31 are formed vertically symmetrically, the present disclosure is not limited thereto. For example, one, two, three, five or more first pressing ribs 311 may be formed on the outer peripheral surface of the cylindrical portion 31.

Each of the four first pressing ribs 311 includes a low height portion 311a located on a tip side portion of the cylindrical portion 31, a middle height portion 311b extending from a base end portion of the low height portion 311a toward the base side, and a high height portion 311c extending from a base end portion of the middle height portion 311b toward the base side.

The low height portion 311a is a protruding portion located on the tip side portion of the cylindrical portion 31 and extending from the tip side portion of the cylindrical portion 31 toward the base side with keeping a constant height. As shown in FIG. 7, in the state that the housing 3 is held by the shell 4, a height (a length in the Y direction) of the low height portion 311a is set so that the low height portion 311a does not contact with an inner peripheral surface of the cylindrical portion 42 of the shell 4.

Referring back to FIG. 11, the middle height portion 311b is located between the low height portion 311a and the high height portion 311c. A tip side portion of the middle height portion 311b is an inclined portion whose height gradually increases from the tip side toward the base side. A tip end surface of the middle height portion 311b is an inclined surface which inclines from the inner side toward the outer side as it extends from the tip side toward the base side. A tip end portion of the tip end surface is continuous with the base end portion of the low height portion 311a. A portion excluding the tip side portion of the middle height portion 311b is a protruding portion extending toward the base side with keeping a constant height. Further, the base end portion of the middle height portion 311b is continuous with a tip end portion of the high height portion 311c. The height of the middle height portion 311b (a protruding amount in the Y direction) is higher than the height of the low height portion 311a and lower than a height of the high height portion 311c. As shown in FIG. 7, in the state that the housing 3 is held by the shell 4, the height (the length in the Y direction) of the middle height portion 311b is set so that an outer surface (a surface perpendicular to the Y direction) of the middle height portion 311b contacts with the inner peripheral surface of the cylindrical portion 42 and the inner peripheral surface of the insertion hole 43 of the shell 4.

In a natural state that no external force is applied to the housing 3, a separation distance in the Y direction between the outer surfaces of the middle height portions 311b on the upper surface of the cylindrical portion 31 and the outer surfaces of the middle height portions 311b on the lower surface of the cylindrical portion 31 is slightly larger than an inner diameter in the Y direction (the height direction) of the cylindrical portion 42 and the insertion hole 43 of the shell 4. With this configuration, when the cylindrical portion 31 is inserted into the cylindrical portion 42 and the insertion hole 43, the outer surfaces of the middle height portions 311b contact with the inner peripheral surface of the cylindrical portion 42 and the inner peripheral surface of the insertion hole 43 of the shell 4, and thus the middle height portions 311b are pressed toward the inner side. As a result, the housing 3 is held by the shell 4. Further, since the housing 3 is made of the clastic insulating material, the cylindrical portion 31 can be elastically deformed toward the inner side. Thus, when the housing 3 is inserted into the cylindrical portion 42 and the insertion hole 43, the outer surfaces of the middle height portions 311b of the four first pressing ribs 311 are pressed toward the inner side by the inner peripheral surface of the cylindrical portion 42 and the inner peripheral surface of the insertion hole 43, and thereby portions of the cylindrical portion 31 where the middle height portions 311b are formed are elastically deformed toward the inner side. As a result, it is possible to allow the inner surfaces of the insertion holes 33 to strongly contact with the protruding portions 27 of the contact pins 2 respectively, thereby preventing the contact pins 2 from being respectively shifted in the insertion holes 33 and from being respectively removed from the insertion holes 33.

Referring back to FIG. 11, the high height portion 311c is located on the base side of the middle height portion 311b and extends from the base end portion of the middle height portion 311b toward the base side with keeping a constant height so as to protrude toward the outer side. A lower side portion of a tip end portion of the high height portion 311c is continuous with the base end portion of the middle height portion 311b. As shown in FIG. 7, in the state that the housing 3 is held by the shell 4, the height (a length in the Y direction) of the high height portion 311c is set so that an outer surface (a surface perpendicular to the Y direction) of the high height portion 311c does not contact with the inner peripheral surface of the insertion hole 43 of the shell 4. In addition, base end portions of the high height portions 311c of the two first pressing ribs 311 formed on the lower surface of the cylindrical portion 31 are connected to a tip surface of a front plate 321 of the downwardly extending portion 32.

The pair of second pressing ribs 312 are formed in order to prevent the contact pins 2 from being respectively shifted in the insertion holes 33 of the housing 3 toward the base side or from being respectively removed from the insertion holes 33, and to prevent the cylindrical portion 31 of the housing 3 from being removed from the cylindrical portion 42 and the insertion hole 43 of the shell 4 in the state that the cylindrical portion 31 is inserted into the cylindrical portion 42 and the insertion hole 43. Further, the pair of second pressing ribs 312 are formed in order to stably keep the separation distance in the width direction (the X direction) between the pair of contact pins 2 respectively held in the pair of insertion holes 33 of the housing 3 constant for improving the signal transmission characteristics of the electrical connector 1.

As shown in FIG. 11, the pair of second pressing ribs 312 are protruding portions linearly extending in the insertion and extraction direction of the mating connector 200 with being spaced apart from each other. The pair of second pressing ribs 312 face each other at an angular interval of 180 degrees through the pair of insertion holes 33 and the wall portion 34 formed between the pair of insertion holes 33. The pair of second pressing ribs 312 are respectively formed on both side surfaces (both side surfaces in the X direction) of the cylindrical portion 31.

Each of the second pressing ribs 312 includes a low height portion 312a located on the tip side portion of the cylindrical portion 31 and a high height portion 312b extending from a base end portion of the low height portion 312a toward the base side.

The low height portion 312a is a protruding portion located on the tip side portion of the cylindrical portion 31 and extending with keeping a constant height as it extends from the tip side toward the base side. In the state that the housing 3 is held by the shell 4, a height (a length in the X direction) of the low height portion 312a is set so that the low height portion 312a does not contact with the inner peripheral surface of the cylindrical portion 42 of the shell 4.

The high height portion 312b is located on the base side of the low height portion 312a. A tip side portion of the high height portion 312b is an inclined portion whose height gradually increases from the tip side toward the base side. A tip end surface of the high height portion 312b is an inclined surface which inclines from the inner side toward the outer side as it extends from the tip side toward the base side. A tip end portion of the tip end surface of the high height portion 312b is continuous with the base end portion of the low height portion 312a. A portion excluding the tip side portion of the high height portion 312b is a protruding portion extending toward the base side with keeping a constant height. A height (a protruding amount in the X direction) of the high height portion 312b is larger than the height of the low height portion 312a.

The high height portion 312b is provided so as to contact with the inner peripheral surfaces of the cylindrical portion 42 and the insertion hole 43 of the shell 4 in the state that the housing 3 is held by the shell 4 in order to prevent the cylindrical portion 31 of the housing 3 from being removed from the cylindrical portion 42 and the insertion hole 43. The height (the length in the X direction) of the high height portion 312b is larger than the height of the low height portion 312a. Further, in the natural state in which no external force is applied to the housing 3, a total length of the outer diameter of the cylindrical portion 31 in the width direction (X direction) and the heights (the protruding amounts) of the pair of high height portions 312b is slightly larger than the inner diameter in the width direction of the cylindrical portion 42 and the insertion hole 43 of the shell 4. With this configuration, when the cylindrical portion 31 is inserted into the cylindrical portion 42 and the insertion hole 43, the outer surfaces of the high height portions 312b contact with the inner peripheral surface of the cylindrical portion 42 and the inner peripheral surface of the insertion hole 43 and are pressed toward the inner side. As a result, the housing 3 is held by the shell 4. Further, the cylindrical portion 31 can be elastically deformed toward the inner side as described above. Thus, when the housing 3 is inserted into the cylindrical portion 42 and the insertion hole 43, the outer surfaces of the high height portions 312b contact with the inner peripheral surface of the cylindrical portion 42 and the inner peripheral surface of the insertion hole 43, and are pressed toward the inner side. As a result, portions of the cylindrical portion 31 where the high height portions 312b are formed are elastically deformed toward the inner side.

The downwardly extending portion 32 is a portion for containing the downwardly extending portions 26 of the contact pins 2 therein when the contact pins 2 are held in the housing 3. As shown in FIGS. 11 and 12, the downwardly extending portion 32 includes the front plate 321 extending from a lower portion of a base side portion of the cylindrical portion 31, a pair of side wall portions 322 respectively extending from both width-direction (X-direction) end portions of the front plate 321 toward the base side, a central wall portion 323 extending toward the base side from a center of the front plate 321 in the width direction between the pair of side wall portions 322 with being spaced apart from the pair of side wall portions 322, cutout portions 35 respectively formed on outer surfaces of the pair of side wall portions 322, and engagement protrusions 36 respectively formed in the pair of cutout portions 35 so as to partition each cutout portion 35 in the front-rear direction.

The front plate 321 is a plate-like portion vertically extending from the lower portion of the base side portion of the cylindrical portion 31 toward the lower side. As shown in FIG. 7, in the state that the insertion of the cylindrical portion 31 of the housing 3 into the insertion hole 43 of the shell 4 from the base side is completed, a tip end surface of the front plate 321 abuts against an inner surface of the body portion 41 of the shell 4.

As shown in FIGS. 11 and 12, the pair of side wall portions 322 are plate-like portions respectively extending from both width-direction end portions of the front plate 321 toward the base side. As shown in FIG. 12, two internal spaces for respectively containing the downwardly extending portions 26 of the pair of contact pins 2 therein are defined by a base end surface of the front plate 321, inner surfaces of the pair of side wall portions 322 and outer surfaces of the central wall portion 323. When the pair of contact pins 2 are held by the housing 3, the downwardly extending portions 26 of the pair of contact pins 2 are respectively located in the two internal spaces of the downwardly extending portion 32 of the housing 3. The central wall portion 323 is a plate-like portion extending from the center of the front plate 321 in the width direction (the X direction) toward the base side. The central wall portion 323 is located between the pair of side wall portions 322 and faces both of the side wall portions 322 through gaps therebetween. The central wall portion 323 partitions between the above-mentioned two internal spaces.

Referring back to FIG. 11, the pair of insertion holes 33 are arranged in the width direction (the X direction) so as to be in parallel to each other and extend in the insertion and extraction direction of the mating connector 200 with being spaced apart from each other through the wall portion 34. Each of the insertion holes 33 pass through the cylindrical portion 31 in the insertion and extraction direction of the mating connector 200 (the Z direction). As described above, the pair of contact pins 2 are respectively press-fitted into the pair of insertion holes 33. Each insertion hole 33 has a shape corresponding to the horizontally extending portion 24 of the contact pin 2 and has a substantially rectangular planar shape in a planar view viewed from the Z direction.

The wall portion 34 is located between the pair of insertion holes 33. The wall portion 34 is a plate-like portion linearly extending in the cylindrical portion 31 from the tip end portion to the base end portion of the cylindrical portion 31 along the insertion and extraction direction of the mating connector 200 (the Z direction) so as to partition the pair of insertion holes 33 adjacent to each other in the width direction.

The cutout portion 35 is a recessed portion formed on a lower portion of the outer surface of each of the side wall portions 322 along the insertion and extraction direction of the mating connector 200 (the Z direction). The cutout portion 35 extends from a substantially central portion in the height direction of the side wall portion 322 toward a lower end portion of the side wall portion 322 and extends from a tip end portion to a base end portion of the side wall portion 322. The cutout portion 35 includes a first recessed portion 351 formed on a tip side portion of the cutout portion 35 and a second recessed portion 352 formed on the base side of the first recessed portion 351. The first recessed portion 351 and the second recessed portion 352 are partitioned by the engagement protrusion 36.

The first recessed portions 351 are thin portion for preventing each of the side wall portions 322 of the housing 3 from contacting with after-mentioned engagement protrusions 49 (see FIG. 15) formed on an inner surface of the shell 4 when the housing 3 is inserted into the shell 4. As shown in FIG. 15, in the state that the housing 3 is housed in the shell 4, an outer surface of each first recessed portion 351 faces the inner surface of the shell 4 through a gap therebetween, and thus does not contact with the inner surface of the shell 4.

The second recessed portions 352 are recesses for respectively containing the engagement protrusions 49 (see FIG. 15) of the shell 4 therein in the state that the housing 3 is contained the shell 4. As shown in FIG. 15, in the state that the housing 3 is contained in the shell 4, an outer surface of each second recessed portion 352 faces the inner surface of the shell 4 except the engagement protrusion 49 of the shell 4 through a gap therebetween, and thus does not contact with the inner surface of the shell 4 except the engagement protrusion 49.

Referring back to FIGS. 11 and 12, the engagement protrusions 36 are protrusions elongated in the height direction (the Y direction) and respectively formed on the outer surfaces of the cutout portions 35 of the side wall portions 322 so as to be located between the first recessed portion 351 and the second recessed portion 352. Each engagement protrusion 36 has a function of engaging with the engagement protrusion 49 of the shell 4 to lock the housing 3 in the shell 4. The engagement protrusion 36 linearly extends in the vertical direction from the upper end portion to the lower end portion of the cutout portion 35. Outer surfaces (surfaces in the X direction) of the engagement protrusions 36 are respectively located on the same planes as the outer surfaces of the side wall portions 322 and located on the outer side of the outer surfaces of the cutout portions 35. The engagement protrusion 36 includes a front slope portion 361 which protrudes from the outer surface of the side wall portion 322 and whose outward protruding amount gradually increases as it extends from the tip side toward the base side, a rear slope portion 362 which protrudes from the outer surface of the side wall portion 322 on the base side of the front slope portion 361 and whose outward protruding amount gradually decreases as it extends from the tip side toward the base side, and a flat portion 363 linearly extending between the front slope portion 361 and the rear slope portion 362 in the insertion and extraction direction of the mating connector 200.

The front slope portion 361 has an inclined structure which protrudes from an outer surface of the first recessed portion 351 and whose outward (X-direction) protruding amount gradually increases as it extends from the tip side toward the base side. A tip end portion of the front slope portion 361 is continuous with the outer surface of the first recessed portion 351. An outer surface of the front slope portion 361 is an inclined surface inclined in the outer direction from the tip side toward the base side. When the housing 3 is inserted into the shell 4, the front slope portion 361 proceeds toward the tip side while sliding on a base end surface (a second inclined surface 492 surface described later, see FIG. 15) of the engagement protrusion 49 of the shell 4.

The rear slope portion 362 has an inclined structure which protrudes from an outer surface of the second recessed portion 352 on the base side of the front slope portion 361 and whose outward protruding amount gradually decreases from the tip side toward the base side. A base end portion of the rear slope portion 362 is continuous with the outer surface of the second recessed portion 352. An outer surface of the rear slope portion 362 is an inclined surface inclined in the inner direction from the tip side toward the base side. As shown in FIG. 15, in the state that the housing 3 is contained in the shell 4, the outer surface of the rear slope portion 362 contacts with a tip end surface (a first inclined surface 491 described later) of the engagement protrusion 49 of the shell 4.

Referring back to FIG. 11, the flat portion 363 linearly extending from a base end portion of the front slope portion 361 to a tip end portion of the rear slope portion 362 and has a constant height from the tip side toward the base side. An outer surface of the flat portion 363 is a flat surface perpendicular to the X direction. As shown in FIG. 15, in the state that the housing 3 is contained in the shell 4, the outer surface of the flat portion 363 does not contact with the inner surface of the shell 4.

Although the engagement protrusion 36 extends from the substantially central portion in the height direction (the Y direction) toward the lower end portion of each of the side wall portions 322 of the downwardly extending portion 32 on the outer surface of each of the side wall portions 322 in the illustrated aspect, a length of the engagement protrusion 36 in the Y direction is not limited thereto. The length of the engagement protrusion 36 of the housing 3 in the Y direction may be smaller or larger than that of the illustrated aspect as long as it can lock the housing 3 in the containing portion 48 in the state that the housing 3 is contained in the containing portion 48 of the shell 4 and the engagement protrusion 36 engages with the engagement protrusion 49 of the shell 4. For example, the engagement protrusion 36 may extend from the upper end portion to the lower end portion of the side wall portion 322.

Referring back to FIG. 8, the shell 4 has a function as a housing for containing the components of the electrical connector 1 therein and a function as an electrical path for electrically connecting between the electrical connector 1 and the ground terminals 110 on the circuit board 100. As shown in FIGS. 13 and 14, the shell 4 is a box-shaped member made of metal material.

The shell 4 includes the body portion 41 constituted of a front plate 411, a pair of side walls 412 and a top plate 413, the cylindrical portion 42 extending from a tip end surface of the front plate 411 of the body portion 41 toward the tip side, a pair of positioning protrusions 421 respectively formed at positions adjacent to an upper portion and a lower portion of a base side portion of the cylindrical portion 42 on the tip end surface of the body portion 41, the insertion hole 43 passing through the front plate 411 of the body portion 41, four ground terminals 44 extending from a lower end portion of the body portion 41 toward the lower side, a pair of wall portions 45 formed on each of the side walls 412 so as to extend in the Z direction with being spaced apart from each other, cover receiving portions 46 respectively formed on outer surfaces of the side walls 412, engagement walls 47 respectively formed on base end portions of the cover receiving portions 46, the containing portion 48 defined by inner surfaces of the front plate 411, the pair of side walls 412 and the top plate 413, and the engagement protrusions 49 protruding from the inner surface of the containing portion 48 toward the inner side.

The body portion 41 includes the front plate 411, the pair of side walls 412 extending from width-direction end portions of the front plate 411 toward the base side, and the top plate 413 extending from an upper end portion of the front plate 411 toward the base side. The body portion 41 has a box-like shape opened toward the base side and the lower side. The cylindrical portion 42 is a cylindrical member formed so as to protrude from the tip end surface of the front plate 411 of the body portion 41 toward the tip side and communicates with the insertion hole 43. The cylindrical portion 42 serves as an outer conductor that covers the cylindrical portion 31 of the housing 3 from the outer side. Further, when the mating connector 200 and the electrical connector 1 are coupled with each other, the cylindrical portion 42 contacts with a corresponding outer contact 240 (see FIG. 20) of the mating connector 200 to make a ground potential of the electrical connector 1 and a ground potential of the mating connector 200 equal to each other.

As shown in FIG. 13, the pair of positioning protrusions 421 are formed so as to protrude from the tip end surface of the front plate 411 of the body portion 41 toward the tip side and extend from an upper surface and a lower surface of the base end portion of the cylindrical portion 42 toward the outer side (the Y direction). An upper surface of the upper positioning protrusion 421 is located on the same plane as an upper surface of the top plate 413. The pair of positioning protrusions 421 are provided in order to perform positioning of the cover 5 with respect to the shell 4. The pair of positioning protrusions 421 are respectively formed at positions and into shapes corresponding to a pair of positioning recesses 52 (see FIG. 17) of the cover 5 described later.

As shown in FIG. 14, the insertion hole 43 is formed so as to pass through the front plate 411 of the body portion 41 in the insertion and extraction direction of the mating connector 200 (the Z direction). Further, the width of the inner diameter (the length in the X direction) of the insertion hole 43 is larger than the height of the inner diameter (the length in the Y direction) of the insertion hole 43, and corresponds to the rounded rectangular planar shape of the cylindrical portion 31 of the housing 3.

As shown in FIG. 7, the insertion hole 43 includes a tip side portion having the substantially same shape as a hollow portion of the cylindrical portion 42, and a base side portion formed so as to be wider than that of the tip side portion. Further, a step portion 431 is formed between the tip side portion and the base side portion of the insertion hole 43. The tip side portion of the insertion hole 43 has the same shape as the hollow portion of the cylindrical portion 42 and communicates with the hollow portion of the cylindrical portion 42. The base side portion of the insertion hole 43 communicates with the containing portion 48. The step portion 431 has an inclined structure whose height gradually decreases from the tip side toward the base side. As shown in FIG. 7, in the state that the housing 3 is contained in the shell 4, the step portion 431 is spaced apart from the tip end surfaces of the first pressing ribs 311 of the housing 3 through a gap therebetween.

Further, as shown in FIGS. 7 and 8, when the cylindrical portion 31 of the housing 3 is inserted into the shell 4, the inner peripheral surface of the insertion hole 43 and the inner peripheral surface of the cylindrical portion 42 contact with the outer surfaces of the middle height portions 311b of the four first pressing ribs 311 of the housing 3. As a result, the outer surfaces of the middle height portions 311b of the four first pressing ribs 311 of the housings 3 are pressed toward the inner side, and thus the portions of the cylindrical portion 31 where the middle height portions 311b are formed are elastically deformed toward the inner side. Further, when the cylindrical portion 31 of the housing 3 is inserted into the cylindrical portion 42 and the insertion hole 43 of the shell 4, the outer surfaces of the high height portions 312b of the pair of second pressing ribs 312 of the housing 3 are pressed toward the inner side by the inner peripheral surface of the cylindrical portion 42 and the inner peripheral surface of the insertion hole 43, and thus the portions where the high height portions 312b of the pair of pressing ribs 312 of the cylindrical portion 31 are elastically deformed toward the inner side. With these elastic deformations of the cylindrical portion 31 toward the inner side, it is possible to lock the contact pin 2 in the insertion hole 33 of the housing 3.

Referring back to FIGS. 13 and 14, the four ground terminals 44 are respectively connected to the corresponding ground terminals 110 (see FIG. 4) of the circuit board 100. The shell 4 is electrically connected to the ground terminals 110 through the ground terminals 44.

The pair of wall portions 45 are provided on each of the side walls 412 of the body portion 41 in order to form the pair of cover receiving portions 46 for respectively receiving a pair of protruding pieces 54 of the cover 5. One of the pair of wall portions 45 is formed on the upper side (+Y direction) portion of each of the side walls 412. The other one of the pair of wall portions 45 is formed on the lower side (−Y direction) portion of each of the side walls 412. The pair of wall portions 45 face each other through the cover receiving portion 46. Inner surfaces (inner surfaces in the Y direction) of the pair of wall portions 45 are connected by the engagement wall 47 to define a base end surface of the cover receiving portion 46. Each of the wall portions 45 extends from a tip end portion of the outer surface of the side wall 412 toward the tip side. A width (a length in the Y direction) of the wall portion 45 gradually increases from the tip side toward the base side. The inner surface of each of the wall portions 45 is a flat surface inclined from the tip side toward the engagement wall 47 located on the base side.

Each of the cover receiving portions 46 is formed between the pair of wall portions 45 on the outer surface of each of the side walls 412 of the body portion 41. The cover receiving portions 46 have a function of respectively receiving the pair of protruding pieces 54 of the cover 5. The cover receiving portion 46 is defined by the outer surface of the side wall 412 of the body portion 41, the inner surfaces of the pair of wall portions 45, and a tip end surface of the engagement wall 47. An opening width of the cover receiving portion 46 in the Y direction gradually decreases from the tip side toward the base side. With this configuration, it is possible to guide attachment of the cover 5 with respect to the shell 4.

The engagement wall 47 is formed at a base end portion of the cover receiving portion 46 and is formed to perform the attachment of the cover 5 with respect to the shell 4. Further, the tip end surface of the engagement wall 47 is an inclined surface that extends obliquely from the outer surface of the side wall 412 of the body portion 41 toward the outer side and the proximal end side (see FIG. 13). A base end surface of the engagement wall 47 is a flat surface perpendicular to the outer surface of the cover receiving portion 46 (see FIG. 14). The engagement wall 47 is located between the pair of wall portions 45 and extend in the vertical direction (the Y direction) to connect between the pair of wall portions 45.

The containing portion 48 is an internal space of the body portion 41 defined by the inner surfaces of the front plate 411, the pair of side walls 412 and the top plate 413 and is a concave portion opened toward the base side and the lower side. The components of the electrical connector 1 are contained in the containing portion 48. The containing portion 48 has guide portions 481 respectively formed on inner surfaces of both side portions of the containing portion 48.

The guide portions 481 are recessed portions respectively located on the inner surfaces of both side portions of the containing portion 48 and formed so as to linearly extend in the insertion and extraction direction of the mating connector 200 (the Z direction). The guide portions 481 are formed at positions respectively corresponding to the pair of second pressing ribs 312 formed on the outer peripheral surface of the cylindrical portion 31. When the cylindrical portion 31 of the housing 3 is inserted into the containing portion 48 from the base side of the body portion 41, each of the second pressing ribs 312 is inserted into the corresponding guide portion 481. With this configuration, it is possible to guide the insertion of the housing 3 into the shell 4.

As shown in FIGS. 14 and 15, the engagement protrusions 49 are protrusions respectively protruding from the inner surfaces of both side portions (i.e., the pair of side walls 412) of the containing portion 48 toward the inner side. As shown in FIG. 15, each engagement protrusion 49 has a tapered shape whose width in the insertion and extraction direction (Z direction) of the mating connector 200 gradually decreases as a distance from the inner surface of the containing portion 48 increases. The engagement protrusions 49 have a function of respectively engaging with the engagement protrusions 36 of the housing 3 in the state that the housing 3 is contained in the containing portion 48 of the shell 4 to lock the housing 3 in the containing portion 48. Each engagement protrusion 49 includes the first inclined surface 491 located on the tip side (the +Z direction side) and the second inclined surface 492 located on the base side (the −Z direction side) of the first inclined surface 491. In the state that the housing 3 is contained in the containing portion 48, the engagement protrusions 49 of the shell 4 are located on the base side of the engagement protrusions 36 of the housing 3.

The first inclined surface 491 is an inclined surface inclined from the outer side toward the inner side as it extends from the tip side toward the base side. A tip end portion of the first inclined surface 491 is continuous with the inner surface of the containing portion 48. As shown in FIG. 15, in the state that the housing 3 is contained in the containing portion 48, the first inclined surface 491 of the engagement protrusion 49 contacts with the base end surface of the rear slope portion 362 of the engagement protrusion 36 of the housing 3.

The second inclined surface 492 is an inclined surface inclined from the inner side to the outer side as it extends from the tip side toward the base side. A tip end portion of the second inclined surface 492 is continuous with a base end portion of the first inclined surface 491. An outer surface of a connecting portion (a top portion of the engagement protrusion 49) between the first inclined surface 491 and the second inclined surface 492 is a curved surface. A base end portion of the second inclined surface 492 is continuous with the inner surface of the containing portion 48. As shown in FIG. 14, in a state that the housing 3 is not contained in the containing portion 48, the first inclined surfaces 491 face the front plate 411 and the second inclined surfaces 492 face the outside. Further, as shown in FIG. 15, in the state in that the housing 3 is contained in the containing portion 48, a part of each first inclined surface 491 contacts with the corresponding rear slope portion 362, and the other part of each first inclined surface 491 faces the front plate 411. Further, when the housing 3 is contained in the containing portion 48, an entire area of each second inclined surface 492 faces the outside on the −Z direction side from the inside of the containing portion 48.

As described above, the first inclined surfaces 491 respectively contact with the base end surfaces of the rear slope portions 362 of the engagement protrusions 36 of the housing 3. As a result, the engagement protrusions 36 of the housing 3 and the engagement protrusions 49 of the shell 4 are engaged with each other. Therefore, even if external force is applied to the housing 3 in the −Z direction when the mating connector 200 is inserted into the electric connector 1, the housing 3 is locked in the containing portion 48 of the shell 4 by engagements between the engagement protrusions 36 and the engagement protrusions 49. Further, in order to increase locking force for the housing 3 in the containing portion 48, each of the engagement protrusions 49 is formed so that an inclination of each first inclined surface 491 with respect to the inner surface of the containing portion 48 is larger than an inclination of each second inclined surface 492 with respect to the inner surface of the containing portion 48.

As described above, the present disclosure is configured so that the housing 3 includes the engagement protrusions 36 respectively protruding from the outer surfaces of the pair of side wall portions 322 of the downwardly extending portion 32 toward the outer side and the shell 4 includes the engagement protrusions 49 respectively protruding from the inner surfaces of both side portions of the containing portion 48 toward the inner side. Thus, in the state that the housing 3 is contained in the containing portion 48 of the shell 4, the housing 3 is locked in the containing portion 48 by the engagements between the engagement protrusions 36 and the engagement protrusions 49.

In order to mount the electrical connector 1 on the circuit board 100, a reflow soldering process is performed. However, stress relaxation of the housing 3 occurs due to heat generated during the reflow soldering process. If the housing 3 is held in the shell 4 only by frictional force on a press-fitting surface between the housing 3 and the shell 4 as is the case in the conventional art, the holding force for the housing 3 in the shell 4 is rapidly reduced due to the stress relaxation of the housing 3. On the other hand, in the present disclosure, the engagement protrusions 36 of the housing 3 and the engagement protrusions 49 of the shell 4 are engaged with each other to lock the housing 3 in the shell 4. Since the holding force for the housing 3 in the shell 4 is provided by the engagements between the engagement protrusions 36 of the housing 3 and the engagement protrusions 49 of the shell 4, the holding force is not reduced by the heat generated during the reflow soldering process. Therefore, even after the reflow soldering process is performed, the holding force for the housing 3 in the shell 4 does not reduce. As a result, even if the mating connector 200 contacts with the cylindrical portion 31 of the housing 3 and the external force is applied to the housing 3 toward the base side when the mating connector 200 is inserted into the electrical connector 1 from the tip side, it is possible to prevent the housing 3 from being shifted in the shell 4 toward the base side, and thereby it is possible to keep contact reliability of the electrical connector 1.

Referring back to FIG. 8, the cover 5 is attached to the shell 4 and has a function of guiding the coupling between the electrical connector 1 and the mating connector 200. As shown in FIGS. 16 and 17, the cover 5 includes a rectangular cylindrical body portion 51 opened toward the tip side and the base side, the pair of positioning recesses 52 formed on a base end surface of the body portion 51, two protrusions 53 formed on a bottom surface (a surface perpendicular to the Z direction) of each of the positioning recesses 52, the pair of protruding pieces 54 extending from the body portion 51 toward the base side, and an engagement protrusion 55 extending from a base side edge portion of an inner surface of each of the protruding pieces 54.

The body portion 51 has a rectangular cylindrical shape opened toward the tip side and the base side. When the mating connector 200 is inserted into a tip side opening of the body portion 51, the coupling between the electrical connector 1 and the mating connector 200 is guided. The body portion 51 further includes a base side opening 511 opened toward the base side and into which the cylindrical portion 42 of the shell 4 is inserted from the base side.

As shown in FIG. 17, each of the positioning recesses 52 is a concave portion formed on the base end surface of the body portion 51. The pair of positioning recesses 52 have a function of respectively containing the pair of positioning protrusions 421 of the shell 4 when the cover 5 is attached to the shell 4. One of the pair of positioning recesses 52 extends in the width direction along an upper end portion of the base side opening 511. The other one of the pair of positioning recesses 52 extends in the width direction along a lower end portion of the base side opening 511. The pair of positioning recesses 52 are respectively formed at positions and shapes corresponding to the pair of positioning protrusions 421 of the shell 4 described above by cutting out the base end surface of the body portion 51 toward the tip side. By respectively inserting the pair of positioning protrusions 421 into the pair of positioning recesses 52, the positioning of the cover 5 with respect to the shell 4 is performed. The two protrusions 53 are formed on the bottom surface of each of the positioning recesses 52 so as to protrude toward the base side. Namely, in the illustrated aspect, the four protrusions 53 are formed in total. When the cover 5 is attached to the shell 4, the upper two protrusions 53 abut against the upper positioning protrusion 421 of the shell 4, and the lower two protrusion 53 abut against the lower positioning protrusion 421 of the shell 4. With this configuration, it is possible to stably perform the positioning of the cover 5 with respect to the shell 4.

The pair of protruding pieces 54 are plate-like portions respectively extending from base end portions of a pair of opposed X-direction side surfaces (wall portions) of the body portion 51 toward the base side. The pair of protruding pieces 54 face each other through a gap therebetween. Each of the protruding pieces 54 has a shape corresponding to each of the above-described cover receiving portions 46 of the shell 4. When the cover 5 is attached to the shell 4, the pair of protruding pieces 54 are respectively contained in the pair of cover receiving portions 46.

The pair of engagement protrusions 55 are formed to respectively engage with the engagement walls 47 formed on the shell 4 to enable the attachment of the cover 5 with respect to the shell 4. The pair of engagement protrusions 55 are tapered portions respectively protruding from the base side edge portions of the inner surfaces of the pair of protruding pieces 54.

Each of the engagement protrusions 55 includes a slope portion 551 located on the base side and a flat portion 552 linearly extending from a tip end portion of the slope portion 551. The slope portion 551 has a base end surface which is continuous with the base end portion of the protruding piece 54 and a height (a length in the X direction) gradually increasing from the base side toward the tip side. An inner surface of the slope portion 551 is an inclined surface inclined toward the inner side as it extends from the base side toward the tip side. When the cover 5 is attached to the shell 4, the slope portion 551 slides on the tip end surface of the engagement wall 47 of the shell 4, and thereby the protruding piece 54 is elastically deformed toward the outer side, gradually. The flat portion 552 linearly extends from the tip end portion of the slope portion 551 with keeping a constant height thereof from the base side toward the tip side. A tip end surface of the flat portion 552 is a flat surface perpendicular to the Z direction. The tip end surface of the flat portion 552 abuts against and engages with the base end surface of the engagement wall 47, and thereby the cover 5 is attached to the tip side portion of the shell 4.

The receiving portion 56 is formed on an upper surface of the body portion 51 and has a function of receiving a positioning protrusion 220 (see FIG. 4) of a case 210 of the mating connector 200. The receiving portion 56 includes an opening 561 through which the positioning protrusion 220 of the case 210 of the mating connector 200 is inserted, a pair of guide portions 562 on which the positioning protrusion 220 of the mating connector 200 are slid to guide the coupling between the electrical connector 1 and the mating connector 200, and a locking portion 563 for locking the positioning protrusion 220 of the case 210 of the mating connector 200.

The opening 561 is a rectangular opening opened in the insertion and extraction direction of the mating connector 200 (the Z direction). By inserting the mating connector 200 into the electrical connector 1 in a posture that the positioning protrusion 220 of the case 210 of the mating connector 200 is inserted into the opening 561, the positioning of the mating connector 200 with respect to the electrical connector 1 is performed. The pair of guide portions 562 are plate-like portions extending from the upper surface of the body portion 51 toward the upper side and facing each other. The positioning protrusion 220 of the case 210 of the mating connector 200 slides on inner surfaces of the pair of guide portions 562, and thereby the coupling between the mating connector 200 and the electrical connector 1 is guided. The locking portion 563 is a plate-like portion for connecting base end portions of the pair of guide portions 562 to each other. The locking portion 563 is a flat surface perpendicular to the insertion and extraction direction of the mating connector 200 (the Z direction). When a tip end portion of the positioning protrusion 220 of the case 210 of the mating connector 200 abuts against the locking portion 563, the insertion of the mating connector 200 into the electrical connector 1 is restricted.

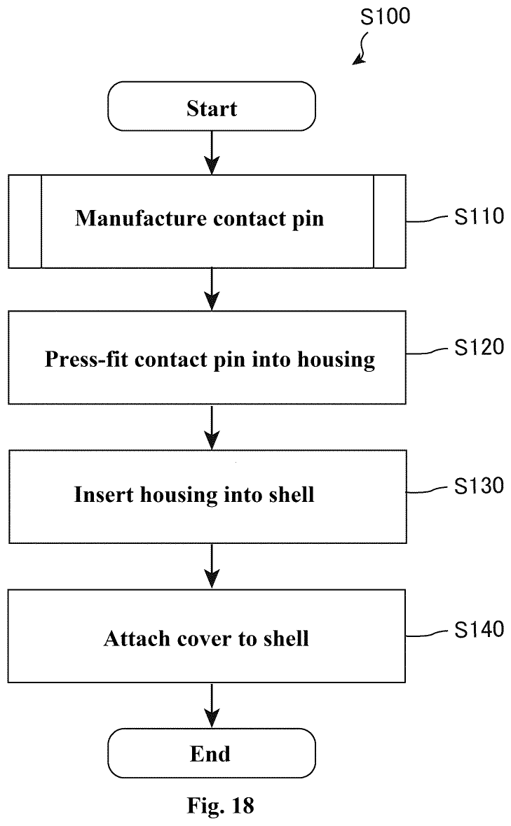

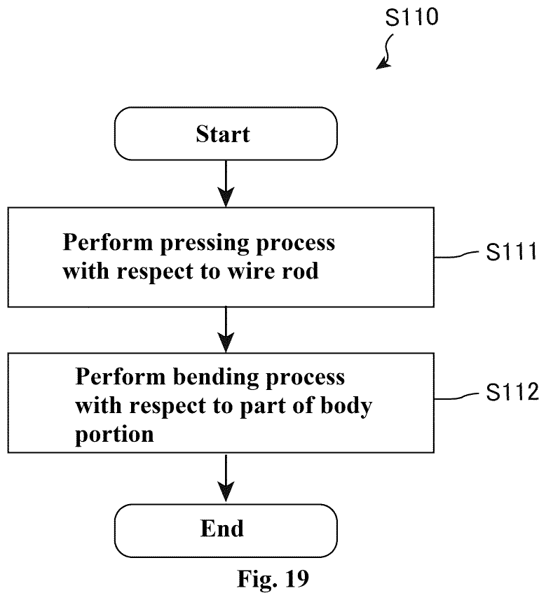

Next, detailed description will be given to a method S100 of manufacturing the electrical connector 1 and a method (a step S110) of manufacturing the contact pin 2 of the electrical connector 1 with reference to FIGS. 18 and 19. FIG. 18 is a flowchart showing the method of manufacturing the electrical connector of the present disclosure. FIG. 19 is a flowchart showing the method of manufacturing the contact pin of the electrical connector of the present disclosure.

A manufacturing method S100 shown in FIG. 18 is performed by an assembling robot or an assembling operator for the electrical connector 1. First, at a step S110, the contact pin 2 is manufactured. As shown in FIG. 19, at a step S111 (a pressing step), the pressing process is performed with respect to the wire rod having the rectangular cross-sectional shape to form the body portion 21 having the rectangular cross-sectional shape, the contact portion 22 extending from the one end portion of the body portion 21, and the terminal portion 23 extending from the other end portion of the body portion 21. Further, the pressing process is performed with respect to portions of the wire rod corresponding to the predetermined portions of the body portion 21 to form the two pairs of protruding portions 27 protruding from the body portion 21 toward the outer side (the Y direction). Further, the pressing process is performed with respect to a portion of the wire rod corresponding to the tip end portion of the body portion 21 to form the pair of tip protruding portions 28 protruding from the body portion 21 toward the outer side (the Y direction). Note that the pressing processes for forming the contact portion 22 and the terminal portion 23 may be performed simultaneously with the pressing process for forming the body portion 21 or may be performed at different timings.

Next, at a step S112 (a bending step), the bending process is performed with respect to a part of the body portion 21 to form the body portion 21 so as to include the horizontally extending portion 24 linearly extending in the insertion and extraction direction of the mating connector 200, the connecting portion 25 extending from the base end portion of the horizontally extending portion 24 toward the lower side, and the downwardly extending portion 26 linearly extending from the lower end portion of the connecting portion 25 toward the lower side. When the contact portion 22, the terminal portion 23, the horizontally extending portion 24, the connecting portion 25, and the downwardly extending portion 26 are formed, the step S110 for manufacturing the contact pin 2 is completed.

As described above, the pair of contact pins 2 in the present disclosure are not obtained by performing the punching process and the cutting process with respect to the metal plate unlike the prior art. The pair of contact pins 2 in the present disclosure are obtained by performing the pressing process (the step S111) and the bending process (the step S112) with respect to the wire rod having the rectangular cross-sectional shape. As a result, it is possible to prevent the change in the shape of the body portion 21 of each of the contact pins 2, in particular, the collapses of the corner portions of the first surface 211 or the second surface 212, and thereby it is possible to prevent the difference between the length L1 of the first surface 211 and the length L2 of the second surface 212 of the body portion 21 from occurring in the cross-sectional shape of the body portion 21. Therefore, it is possible to improve the signal transmission characteristics of the electric connector 1.

Further, in the method (the step S110) of manufacturing the contact pin 2 of the present disclosure, there is no cut mark which is conventionally formed on the body portion 21 of the contact pin 2 when the contact pin 2 is obtained by performing the punching process and the cutting process with respect to the metal plate. Therefore, it is possible to form the contact pin 2 of the present disclosure into a simpler shape than the conventional contact pin obtained by performing the pressing process and the punching process with respect to the metal plate to punch the metal plate into a predetermined shape. In this regard, although the step S112 (the bending process) is performed after the step S111 (the pressing process) in the flow chart shown in FIG. 19, this order may be reversed.

Referring back to FIG. 18, at a step S120, the pair of contact pins 2 are respectively press-fitted into the pair of insertion holes 33 of the housings 3 by using an appropriate press-fitting tool. Since the press-fitting of the pair of contact pins 2 into the pair of insertion holes 33 of the housing 3 is performed by the same procedure, a procedure of press-fitting one of the contact pins 2 into corresponding one of the insertion holes 33 of the housing 3 will be described in detail as a representative.

First, the contact portion 22 of the contact pin 2 is inserted into the insertion hole 33 of the housing 3. Next, the connecting portion 25 of the contact pin 2 is pressed toward the tip side to press-fit the contact pin 2 into the insertion hole 33 of the housing 3. When the tip end surface of the downwardly extending portion 26 of the contact pin 2 contacts with the base end surface of the front plate 321, the press-fitting of the contact pin 2 into the insertion hole 33 is completed. By the same procedure, the other one of the contact pins 2 is press-fitted into the other one of the insertion holes 33.

Next, at a step S130, the housing 3 in which the pair of contact pins 2 are press-fitted is inserted into the containing portion 48 of the shell 4 from the base side and further inserted into the insertion hole 43. The insertion of the housing 3 into the insertion hole 43 is completed when the cylindrical portion 31 is inserted into the cylindrical portion 42 of the shell 4 and the tip end surface of the front plate 321 of the housing 3 contacts with the base end surface of the front plate 411 of the shell 4.

Further, at a step S130, the cylindrical portion 31 of the housing 3 is inserted into the cylindrical portion 42 of the shell 4. At this time, the front slope portions 361 of the pair of engagement protrusions 36 of the housing 3 respectively slide on the second inclined surfaces 492 of the pair of engagement protrusions 49 of the shell 4. As the downwardly extending portion 32 moves toward the tip side in the containing portion 48, the pair of side wall portions 322 are elastically deformed toward the inner side. When the front slope portions 361 of the engagement protrusions 36 respectively exceed the top portions of the engagement protrusions 49, the top portions of the engagement protrusions 49 respectively slide on the flat portions 363 of the engagement protrusions 36 as the downwardly extending portion 32 moves toward the tip side in the containing portion 48. When the flat portions 363 exceed the top portions of the engagement protrusions 49, the side wall portions 322 are elastically restored toward the outer side, and thereby the engagement protrusions 36 are engaged with the engagement protrusions 49 by the snap fit. As shown in FIG. 15, the outer surfaces of the rear slope portions 362 of the engagement protrusions 36 respectively contact with and engage with the first inclined surfaces 491 of the engagement protrusions 49. With this configuration, it is possible to lock the housing 3 in the containing portion 48 of the shell 4, thereby preventing the housing 3 from being removed from the shell 4 toward the base side.

When the housing 3 is completely inserted into the shell 4, the middle height portions 311b of the four first pressing ribs 311 and the outer surfaces of the high height portions 312b of the pair of second pressing ribs 312 formed on the cylindrical portion 31 contact with the inner peripheral surface of the cylindrical portion 42 and the inner peripheral surface of the insertion hole 43. Therefore, the cylindrical portion 31 is fixed in the cylindrical portion 42 and the insertion hole 43.

Finally, at a step S140, the cover 5 is attached to the shell 4 from the tip side. Specifically, the tip side portion of the shell 4 is press-fitted into the base side portion of the cover 5 in the posture that the pair of protruding pieces 54 of the cover 5 are respectively inserted into the pair of cover receiving portions 46 of the shell 4. At this time, the slope portions 551 of the pair of protruding pieces 54 respectively slide on the tip end surfaces of the engagement walls 47 of the shell 4. As the shell 4 is inserted into the cover 5, the pair of protruding pieces 54 are elastically deformed and opened toward the outer side. When the pair of engagement protrusions 55 respectively exceed the base end surfaces of the engagement walls 47, the pair of protruding pieces 54 are elastically restored toward the inner side and are respectively engaged with the engagement walls 47 by the snap fit. The engagements due to this snap fit completes the attachment of the cover 5 with respect to the tip side portion of the shell 4. When the cover 5 is attached to the shell 4 as described above, the method S100 of manufacturing the electrical connector 1 is completed.

FIG. 20 is a cross-sectional view of the electrical connector 1 and the mating connector 200 in the state that the electrical connector 1 and the mating connector 200 are coupled with each other, which is taken along a YZ plane including the contact pin 2. As shown in FIG. 20, the mating connector 200 is inserted into the electrical connector 1 from the tip side to couple the electrical connector 1 with the mating connector 200. In this state, the contact portions 22 of the contact pins 2 of the electrical connector 1 contact with the corresponding contact pins 230 of the mating connector 200. The contact pins 230 of the mating connector 200 are connected to the corresponding core wires 310 of the coaxial cable 300. Therefore, in the state that the electrical connector 1 and the mating connector 200 are coupled with each other, the contact pins 2 of the electrical connector 1 are electrically connected to the corresponding core wires 310 of the coaxial cable 300 through the corresponding contact pins 230 of the mating connector 200.

Further, the cylindrical portion 42 of the shell 4 of the electrical connector 1 contacts with the corresponding outer contact 240 of the mating connector 200. The outer contact 240 of the mating connector 200 is connected to the outer conductor layer 340 of the coaxial cable through conductive members 250, 260. Therefore, in the state that the electrical connector 1 and the mating connector 200 are coupled with each other, the cylindrical portion 42 of the shell 4 of the electrical connector 1 is electrically connected to the outer conductor layer 340 of the coaxial cable 300 through the corresponding outer contact 240 of the mating connector 200.

As described above, each of the contact pins 2 of the electrical connector 1 of the present disclosure is obtained by performing the pressing process (the step S111) and the bending process (the step S112) with respect to the wire rod having the rectangular cross-sectional shape. Thus, unlike the contact pin obtained by performing the punching process and the cutting process with respect to the metal plate, the collapses of the corner portions (the first corner, the second corner, the third corner, and the fourth corner) of the first surface 211 or the second surface 212 of the body portion 21 do not occur in the method of manufacturing the contact pin 2. Thus, the shape of the body portion 21 does not change. In particular, in the cross-sectional shape of the body portion 21 of the contact pin 2, the length L1 of the first surface 211 and the length L2 of the second surface 212 are substantially equal to each other. According to the present disclosure, it is possible to prevent the length L1 of the first surface 211 of the body portion 21 and the length L2 of the second surface 212 from being different from each other in the cross-sectional shape of the body portion 21 as described above, and thereby it is possible to improve the signal transmission characteristics of the electric connector 1.

Further, according to the present disclosure, each of the contact pins 2 of the electrical connector 1 is obtained by performing the pressing process with respect to the wire rod having the rectangular cross-sectional shape and is not obtained by performing the punching process in which the metal plate is pressed and punched into the predetermined shape. Thus, it is possible to set each of the length L1 of the first surface 211, the length L2 of the second surface 212, the length L3 of the third surface 213, and the length L4 of the fourth surface 214 of the contact pin 2 to a length more suitable for the signal transmission characteristics, and thereby it is possible to improve the signal transmission characteristics of the electrical connector 1. For example, according to the present disclosure, it is possible to set the lengths L1, L2 of the contact pin 2 less than 1.5 times of the length L3, L4 as needed.

Further, according to the present disclosure, the opposite inner surfaces of the body portions 21 of the pair of contact pins 2 (the second surface 212 of the contact pin 2 located on the +X direction side and the first surface 211 of the contact pin 2 located on the −X direction side) of the electrical connector 1 are flat surfaces perpendicular to the X direction. With this configuration, it is possible to keep the separation distance between the pair of contact pins 2 in the X direction constant. By keeping the separation distance between the pair of contact pins 2 in the X direction constant, it is possible to stabilize the signal transmission characteristics of the electrical connector 1.

Although the electrical connector of the present disclosure and the method of manufacturing the contact pin of the electrical connector have been described based on the illustrated embodiment, the present disclosure is not limited thereto. Each configuration of the present disclosure can be replaced with any configuration capable of performing the same function, or any configuration can be added to each configuration of the present disclosure.

A person having ordinary skills in the art and the technique pertaining to the present disclosure may modify the configuration of the electrical connector of the present disclosure described above without meaningfully departing from the principle, the spirit and the scope of the present disclosure and the electrical connector having the modified configuration is also involved in the scope of the present disclosure.

Further, the number and the types of components of the electrical connector illustrated in FIGS. 4 to 17 and 20 are merely illustrative examples, and the present disclosure is not necessarily limited thereto. Aspects in which any component is added or combined or in which any component is deleted without departing from the principle and the intent of the present disclosure are also involved within the scope of the present disclosure. Further, the number and types of steps of the method of manufacturing the electrical connector and the method of manufacturing the contact pin of the electrical connector shown in FIGS. 18 and 19 are merely illustrative examples, and the present disclosure is not necessarily limited thereto. Aspects in which any step is added or combined for any purpose or in which any step is deleted without departing from the principle and the intent of the present disclosure are also involved within the scope of the present disclosure.

1. An electrical connector which can be coupled with a mating connector inserted from a tip side thereof, comprising:
a pair of contact pins; and
an insulating housing for containing the pair of contact pins therein in a state that the pair of contact pins are insulated from each other,
wherein each of the pair of contact pins includes a body portion having a rectangular cross-sectional shape,
wherein the body portion of each of the pair of contact pins includes:
an outer surface and an inner surface facing each other, and
a third surface and a fourth surface facing each other,
wherein the inner surfaces of the pair of contact pins face each other through a gap therebetween, and
wherein the body portion of each of the pair of contact pins further includes a recessed portion formed on the outer surface and a pair of protruding portions respectively protruding from portions of the third surface and the fourth surface adjacent to the recessed portion toward an outer side.

2. The electrical connector as claimed in claim 1, wherein each of the pair of contact pins further includes a contact portion extending from one end portion of the body portion and a terminal portion extending from another end portion of the body portion,
wherein the third surface and the fourth surface of the body portion are perpendicular to the outer surface and the inner surface of the body portion,
wherein a ratio of a length of the outer surface and a length of the inner surface satisfies a relationship of 0.9 to 1.1 in a cross-sectional shape of the body portion, and
wherein the third surface and the fourth surface of the body portion are parallel to each other in the cross-sectional shape of the body portion.

3. The electrical connector as claimed in claim 2, wherein the outer surface and the inner surface of the body portion are parallel to each other.

4. The electrical connector as claimed in claim 2, wherein the body portion includes a horizontally extending portion extending in an insertion and extraction direction of the mating connector, a connecting portion bending from a base end portion of the horizontally extending portion toward a lower side and a downwardly extending portion linearly extending a lower end portion of the connecting portion toward the lower side, and
wherein each of the horizontally extending portion, the connecting portion and the downwardly extending portion is configured so that the ratio of the length of the outer surface and the length of the inner surface satisfies the relationship of 0.9 to 1.1 in its cross-sectional shape and the third surface and the fourth surface are parallel to each other in its cross-sectional shape.

5. The electrical connector as claimed in claim 1, wherein the housing includes a pair of insertion holes into which the pair of contact pins should be respectively inserted, and
wherein the pair of protruding portions of the contact pin engage with an inner surface of corresponding one of the insertion holes of the housing, and thereby the contact pin is locked in the corresponding one of the insertion holes of the housing.

6. The electrical connector as claimed in claim 2, wherein the length of the outer surface and the length of the inner surface are less than 1.5 times of a length of the third surface or a length of the fourth surface.

7. A method of manufacturing each of a pair of contact pins used for an electrical connector which can be coupled with a mating connector inserted from a tip side thereof and includes the pair of contact pins and an insulating housing for containing the pair of contact pins therein in a state that the pair of contact pins are insulated from each other, the method comprising:
pressing both end portions of a wire rod having a rectangular cross-sectional shape to form the contact pin including:
a body portion having a rectangular cross-sectional shape,
a contact portion extending from one end portion of the body portion, and
a terminal portion extending from another end portion of the body portion.

8. The method of manufacturing each of the pair of contact pins as claimed in claim 7, further comprising bending a part of the body portion after the pressing is performed to form the body portion including:
a horizontally extending portion linearly extending in an insertion and extraction direction of the mating connector,
a connecting portion bending from a base end portion of the horizontally extending portion toward a lower side, and
a downwardly extending portion linearly extending from a lower end portion of the connecting portion toward the lower side.

9. The method of manufacturing each of the pair of contact pins as claimed in claim 7, wherein a pressing process is performed with respect to a predetermined portion of the body portion of the wire rod in the pressing to form a pair of protruding portions protruding from the body portion toward an outer side.
